(19) United States
(12) Patent Application Publication
(10) Pub. No.: US 2020/0273022 A1
(43) Pub. Date: Aug. 27, 2020

(54) CARD-LESS TRANSACTION SYSTEMS AND TECHNIQUES

(71) Applicant: HalCash North America, Inc., Chatham, NJ (US)

(72) Inventors: Paul McFarren, Upper Saddle River, NJ (US); Jan Stobbe, Saddle River, NJ (US); Richard Witkowski, Upper Saddle River, NJ (US); James Leroux, Millersville, MD (US)

(21) Appl. No.: 16/281,378

(22) Filed: Feb. 21, 2019

(51) Int. Cl. G06Q 20/36; G06Q 20/10; G06Q 20/40

(52) U.S. Cl. CPC G06Q 20/3674; G06Q 20/401; G06Q 20/10

(57) ABSTRACT

Systems and techniques are disclosed for securely managing card-less transactions, e.g., disbursements of paper currency, without using a payment card, between sending entities and recipients. In some implementations, an order for a card-less transaction involving a disbursement of funds from the sending entity to a recipient is received. The order includes a first set of credential data, and a first token that is uniquely associated with a funding account of the sending entity. A set of one or more eligible disbursement devices is identified. The order is determined to be valid. A communication that includes at least the first set of credential data and identifies the set of one or more eligible disbursement devices is provided to a computing device associated with the recipient. The disbursement request is determined to be valid. The particular disbursement device is then configured to execute the disbursement of funds specified by the card-less transaction.

### TECHNICAL FIELD

This specification generally describes technology related to electronic transaction systems, and more particularly, to technology related to payment protocols, payment architectures, and payment network and banking systems.

### BACKGROUND

Automated teller machines (ATMs) can be used to disburse funds to account holders and other authorized users of a transaction account that have been issued payment cards on the transaction account. An individual can insert a payment card into an ATM, authenticate themselves using a personal identification number (PIN), and then be able to perform a number of different functions right from the ATM, such as cash withdrawals, balance inquiries, fund transfers, etc. ATMs often enable individuals to perform actions related to a transaction account at flexible days and times, and often in locations that would not be conducive to a full, staffed branch for the related financial institution.

### SUMMARY

This disclosure describes systems and techniques for securely managing card-less transactions, e.g., disbursements of paper currency, without the use of a payment card, between sending entities and recipients. For example, a recipient can access funds from a disbursement device without having to present a debit or credit card or even having a bank or other financial account. This architecture allows a disbursement of funds between a sending entity and recipient that do not have accounts with the same banking system and without requiring the recipient to use a payment card for transaction authorization. A sending entity with a funding account with a banking system can therefore allow a recipient that does not have an account with the banking system to access funds from the funding account without having to present a payment card at a disbursement device (e.g., an ATM).

The systems disclosed herein include a server that is managed by a service provider that is independent and distinct from a banking system associated with the sending entity or the entity managing the disbursement device. For example, the service provider can be an organization that is not affiliated with the banking system and does not operate within the software ecosystem of the banking system. Since the server is independently operated, the banking system may impose security requirements to reduce the exposure of sensitive financial information that is processed and stored outside the banking system ecosystem. The server is configured to operate to meet these security requirements with the use of tokens to reduce the exposure of sensitive financial information that it processes and stores. For example, the server stores a personal account number (PAN) token assigned to a funding account of a sending entity in lieu of the account number of the funding account so that the account number is not stored or otherwise accessible from its associated databases. As another example, the server stores a virtual payment card number (VCN) token corresponding to the actual VCN that is used for transaction settlement between a disbursement device and a banking system so that the VCN itself is not stored or accessible from its databases. In this way, the server ensures that secure financial information exchanged between participants (e.g., a sending entity, a banking system, a disbursement device owner, a recipient) while processing a transaction is not traceable to the funding account or VCN itself if the server is ever breached or compromised.

An example of a simplified card-less transaction is as follows. The server initially receives an order request for a transaction to disburse funds from a sending entity. The sending entity is associated with a funding account within a banking system. Upon receiving the order request, the server identifies a computing device of a recipient identified in the order request. The server generates credential information that uniquely identifies the transaction, and transmits a communication with the credential information to the computing device of the recipient. The server has previously exchanged communications with a set of eligible disbursement devices (i.e., disbursement devices that are configured to participate in a card-less transaction program) so that the recipient can use them to access funds. When the recipient attempts to obtain the funds at an eligible disbursement device, the server obtains transaction information submitted by the recipient and determines whether submitted transaction information matches verified transaction information obtained from the sending entity. This transaction authorization technique thereby allows a server to manage funds disbursement securely without the use of a payment card as in traditional funds withdrawals, which traditional withdrawals are performed by conventional systems that lack the centralized architecture disclosed herein for managing transactions between independent entities.

The technology described herein provides various improvements over conventional systems. For example, the technology described herein improves upon conventional card-based transaction systems since it permits disbursement of funds in scenarios where a recipient may not have access to a payment card, for instance, in emergency situations, if the recipient has lost access to their payment cards or if the recipient does not have a bank or financial account. Conventional card-based transaction systems are unable to permit disbursement of funds in these scenarios since their methods of transaction authorization rely on the presence of a payment card (or other form of physical identification) at the disbursement device. The technology described herein enables the use of mobile devices to authenticate a recipient without requiring a payment card, which presents an entirely different process for performing transaction authorization than those used by conventional card-based transaction systems.

As another example, the technology described herein improves upon payment systems that allow banked consumers to request and use a virtual card for their account at an ATM. With such systems, a consumer with a financial account can utilize either physical or virtual payment cards to make a withdrawal for certain ATM machines and other disbursement devices. Where a virtual payment card is used for the withdrawal, this is typically stored, or otherwise communicated to, a consumers' mobile device by, or on behalf of, the financial institution with whom the consumer has an account. This process is distinct from the card-less transactions described herein where the recipient only utilizes the credentials received from a server and the sending entity to access the funds and does not need to have a pre-existing financial account with the sending entity.

As yet another example, the technology described herein also improves upon other card-less transaction systems since it addresses inherent security risks often involved in decentralized disbursement of funds (i.e., transactions between a sending entity and recipient that are not within the same banking system ecosystem). While some card-less transaction systems enable sending entities and recipients of different banking systems to exchange funds, they often involve a third-party payment processor that obtains access to sensitive financial information, such as account numbers, routing numbers, etc. These types of payment protocols provide risk of exposure to external entities, and thereby increase the likelihood of fraudulent activity, among other types of security breaches. As discussed above, the technology described herein addresses these inherent security risks by using a centralized server that stores tokens as opposed to account information in processing transactions. By storing tokens, transaction records that are accumulated by the server are rendered untraceable to the funding accounts from which disbursements are processed, which reduces the likelihood of unauthorized exposure if the server becomes compromised.

The technology described herein can also provide capabilities that are not capable of being performed by conventional systems due to technological limitations. For example, the server can provide sending entities (e.g., organizations that perform card-less transaction orders to recipients) with a single interface for initiating transactions orders to be processed by the server. The interface can be provided through a front-end system that includes a web-based portal, a single defined data model and the other components, such as application programming interfaces (API), to support the functions performed by the server. A single front-end system can be used to process transaction orders through the server, even if the orders are disbursed in different countries or via different disbursement platforms. The server also provides a user interface that allows sending entities with flexible methods to communicate transaction orders to recipients.

As another example, the server can be configured to integrate and operate with disparate disbursement platforms and machines in different countries that each have different disbursement requirements, processes and/or regulations. The server can execute these different processes and protocols without requiring a corresponding change to the API or front-end web-based portal. In this way, the server “shields” issuing financial institutions and sending entities from the underlying complexity of integrations involved with various disbursement platforms while providing the sending entities with full access to these disparate platforms for order disbursements.

In some implementations, the server provides the administrators for the server, participating financial institutions and sending entities with a set of dynamic controls to customize and control the creation of transaction orders to meet their specific needs. The server provides a hierarchy of customizable controls and limits that allow the administrators for the server, participating financial institutions and sending entities to manage potential risks associated with transactions. Examples of controls include limits on individual order sizes and aggregated amounts, and limits on volumes and velocities that can be set for the entire system, specific participating banking systems, specific sending entities, specific funding accounts, specific programs or campaigns of the sending entities, certain recipients, or certain countries. The server applies these controls to evaluate each transaction order to determine if order parameters are within the applicable limits specified by the controls. The server can also use real-time “counters” and only permit an order to be created if it passes all applicable control limits.

In some other implementations, the server provides dynamic messaging capabilities in connection with its card-less transactions. For example, the server can allow sending entities to provide messages to recipients through a mobile application. This can be accomplished by enabling, tracking, storing and acting upon a variety of outbound and inbound messages to and from a recipient as well as monitoring a recipient's activities in relation to a transaction. The server can also enable sending entities to intervene at various times to send additional communications unrelated to a transaction order, but also use the same communication channel and communication identifier (e.g., the same sender identifier for the text messages), which enables additional interactions as part of the same communication stream.

Additionally, the server can improve transaction processing by allowing a sending entity to use dynamic authorization parameters. For example, the server can allow a sending entity, when submitting a transaction order, to set data parameters controlling and/or limiting the way a transaction is disbursed. The transaction controls can be configured with information obtained from different data sources, such as data stored by the server in relation to an applicable disbursement device (e.g., location, brand, type, etc.), data that is determined by the server in relation to a requested authorization (e.g., request time, request date), data transmitted from the disbursement device to the server in connection with the authorization request (e.g., transaction purchase amount, purchased product). In some instances, transaction order limitations can be communicated to the recipient. In some implementations, the server can obtain various types of data from external services (e.g., the current location of the recipient). When a transaction is only available at certain disbursement devices, the server can provide a disbursement device locator to the recipient to display only those disbursement devices that can process the transactions as specified by the sending entity.

In one general aspect, a computer-implemented method includes: receiving, by a server system and from a computing system of a sending entity, an order for a card-less transaction involving a disbursement of funds from the sending entity to a recipient, the order including (i) a first set of credential data associated with the card-less transaction, and (ii) a first token that is uniquely associated with a funding account of the sending entity. The method also includes identifying, by the server system, a set of one or more eligible disbursement devices for the disbursement of the funds and determining, by the server system, that the order is valid based at least on the first token and the identification of the set of one or more eligible disbursement devices for the disbursement of the funds. The method further includes providing, by the server system and to a computing device associated with the recipient, a communication that includes at least the first set of credential data associated with the card-less transaction and identifies the set of one or more eligible disbursement devices. The method further includes receiving, by the server system and from a particular disbursement device from among the set of one or more eligible disbursement devices, data indicating (i) a disbursement request received at the particular disbursement device, and (ii) a second set of credential data received at the particular disbursement device in association with the disbursement request. The method further includes determining, by the server system, that the disbursement request is valid based on at least a comparison of the first set of credential data and the second set of credential data. The method further includes configuring, by the server system, the particular disbursement device to execute the disbursement of funds specified by the card-less transaction based on (i) the determination that the order is valid and (ii) the determination that the disbursement request is valid.

One or more implementations can include the following optional features. For instance, in some implementations, the funding account of the sending entity is associated with a banking computing system that is managed by a banking entity. Additionally, in such implementations, the server system is managed by a third-party service provider that is independent and distinct from the sending entity and the banking entity.

In some implementations, validating the order includes: obtaining, by the server system and from the banking computing system, a verified token corresponding to the funding account of the sending entity; determining that the first token matches the verified token; and determining, by the server system, that the order is valid based on at least determining that the first token matches the verified token.

In some implementations, the method further includes providing, by the server system and to the banking computing system, an instruction to create a virtual payment card number that (i) is specific to the card-less transaction and (ii) configured to be used by the particular disbursement device to perform transaction authorization and settlement in association with the disbursement request. The method additionally includes receiving, by the server system and from the banking computing system responsive to providing the request for creation of the virtual payment card number, data indicating a second token uniquely associated with the virtual payment card number.

In some implementations, configuring the particular disbursement device includes: receiving, by the server and from the particular disbursement device, data indicating the disbursement request received at the particular disbursement device; based on receiving the data indicating the disbursement request received at the particular disbursement device, providing, by the server system, the second token to the banking computing system; receiving, by the server system and from the banking computing system, the virtual payment card number created by the banking computing system for the card-less transaction; providing, by the server system and to the particular disbursement device, an instruction that includes the data indicating the virtual payment card number corresponding to the order and identifying the banking computing system. Additionally, the instruction, when received by the particular disbursement device, causes the particular disbursement device to: (i) perform transaction authorization and settlement in association with the disbursement request using the virtual payment card number, and (ii) execute the disbursement of funds specified by the card-less transaction based on performance of the transaction authorization and settlement.

In some implementations, the method additionally includes, after providing the instruction that includes the virtual payment card number to the particular disbursement device, deleting, by the server system, any data instances representing the virtual payment card number at the server system. The method additionally includes storing, by the server system, the first token and the second token in a record for the card-less transaction within an order repository.

In some implementations, configuring the particular disbursement device includes: identifying a service provider that manages the particular disbursement device; and providing, by the server system and to the banking computing system, an instruction to perform transaction settlement with the service provider that manages the particular disbursement device.

In some implementations, the first set of credential data includes: a phone number of a computing device associated with the recipient; a transaction value of the card-less transaction; and a secret code generated for the card-less transaction by sending entity.

In some implementations, the method further includes generating, by the server system, a transaction identifier of the card-less transaction based on the first set of credential data. Additionally, the communication provided to the computing device associated with the recipient specifies the transaction identifier of the card-less transaction. Moreover, the second set of credential data includes: a transaction identifier specified by the recipient at the particular disbursement device; a transaction value specified by the recipient at the particular disbursement device; an identifier associated with the particular disbursement device; and a secret code provided to the recipient in association with the card-less transaction.

In some implementations, identifying the set of one or more eligible disbursement devices for the disbursement of the funds includes: determining a location of the computing device associated with the recipient; and identifying one or more eligible disbursement devices within a threshold proximity to the location of the computing device associated with the recipient.

In some implementations, the method additionally includes providing, by the server system and to the computing device of the recipient, a communication indicating the one or more eligible disbursement devices that are identified to be within the threshold proximity to the location of the computing device associated with the recipient.

In some implementations, determining that the order is valid includes determining that the funding account of the sending entity contains sufficient funds for creation of the order.

In some implementations, after determining that the order is valid, the method further includes: generating, by the server system, an instruction that, when received by a computing system associated with the funding account of the sending entity, causes the computing system associated with the funding account of the sending entity to reduce available funds associated with the funding account pending the disbursement of funds specified by the card-less transaction; and providing, by the server system, the instruction for output to the computing system associated with the funding account of the sending entity.

In some implementations, the instruction includes an expiration date that causes the computing system associated with the funding account of the sending entity to reverse reduction of the available funds associated with the funding account if funds specified by the card-less transaction have not been disbursed by the expiration date.

In another general aspect, a computer-implemented method includes: obtaining, by a server system, data indicating a disbursement device to be used for a disbursement of funds; generating, by the server system, a first set of access credentials for the disbursement device; providing, by the server system, the first set of access credentials to the disbursement device; after providing the first set of access credentials to the disbursement device, receiving, by the server system and from the disbursement device, a second set of access credentials included with a disbursement request received at the disbursement device; determining, by the server system, that the disbursement request is valid based on the first set of access credentials and the second set of access credentials; and providing, by the server system, an access token to the disbursement device based on the determination that the disbursement request is valid.

One or more implementations may include the following optional features. In some implementations, the first set of access credentials includes a verified digital certificate and a verified symmetric key for the disbursement device. Additionally, the second set of access credentials includes a digital certificate included with the disbursement request received at the disbursement device and encryption data encrypted with the verified symmetric key. Further, determining that the disbursement request is valid includes: determining that the digital certificate included with the disbursement request matches the verified digital certificate, and determining that the encryption data matches data stored by the server system for the transaction.

In some implementations, the access token is valid for a specified time period. Additionally, the disbursement device, upon receiving the access token, is configured to (i) permit the disbursement of funds during the specified time period, and (ii) deny the disbursement of funds after the specified time period.

In some implementations, the disbursement device is managed by a service provider that is independent and distinct from an entity that manages the server system.

The details of one or more implementations are set forth in the accompanying drawings and the description below. Other potential features and advantages will become apparent from the description, the drawings, and the claims.

### BRIEF DESCRIPTION OF THE DRAWINGS

FIG. 1 illustrates an example of an architecture for processing card-less transactions.

FIGS. 2A and 2B illustrate examples of techniques involved in processing a card-less transaction order. FIG. 2A illustrates registration between a sending entity and a banking system. FIG. 2B illustrates validation and generation of an order for a card-less transaction.

FIGS. 3A-1, 3A-2, and 3A-3 illustrates an example of a transaction settlement technique that uses a virtual payment card number to process a card-less transaction.

FIG. 3B illustrates an example of a transaction settlement technique that can be used to process a card-less transaction without a virtual payment card number.

FIG. 4 illustrates an example of a front-end processor that enables a sending entity to create orders for card-less-transactions.

FIG. 5 illustrates an example of a back-end processor that performs verification procedures involved in processing a card-less transaction.

FIG. 6 illustrates an example of a hierarchical transaction control model that can be applied in processing card-less transactions with different types of entities.

FIG. 7 illustrates an example of card-less transaction system that can process transactions originating from multiple countries.

FIG. 8 illustrates an example of a system for processing direct disbursement card-less transactions

FIG. 9 illustrates an example of a technique for processing a card-less transaction.

FIG. 10 illustrates an example of a computer system that may be applied to any of the computer-implemented methods and other techniques described herein.

In the drawings, like reference numbers represent corresponding parts throughout.

### DETAILED DESCRIPTION

This disclosure describes systems and techniques for securely managing card-less transactions, e.g., disbursements of paper currency, without the use of a payment card, between sending entities and recipients. For example, a recipient can obtain funds from a disbursement device without having to present a debit or credit card or have a bank or other financial account. This architecture allows a disbursement of funds between sending entities and recipients that do not have accounts with the same banking system and without the use of a payment card for transaction authorization. A sending entity with a funding account with a banking system can therefore allow a recipient that does not have an account with the banking system to access funds from the funding account without having to present a payment card at a disbursement device (e.g., an ATM).

As described throughout, a “transaction” refers to an agreement between a sending entity and recipient regarding a financial instrument, such as funds represented by paper currency. For example, a transaction can refer to a transfer of funds from a sending entity to a recipient which the recipient accesses in the form of paper currency. Transactions, as described herein, can include electronic transactions, e g., transactions recorded on or using a computing device.

As described throughout, a “card-less transaction” refers to a transaction involving a disbursement of funds that does not require a recipient to present a payment card at a disbursement device. As an example, a card-less transaction can be one where a recipient withdraws cash from an ATM machine without the use of a debit or credit card. In this example, the recipient submits certain credential information (e.g., phone number, secret code, order ID, etc.) that is assigned to a transaction order to verify that he/she is authorized to perform the transaction. A server compares the credential information received at the ATM machine to verified credential information assigned to the transaction to determine whether the recipient's disbursement request is valid. In this way, the server can perform transaction authorization without requiring the recipient to submit a payment card.

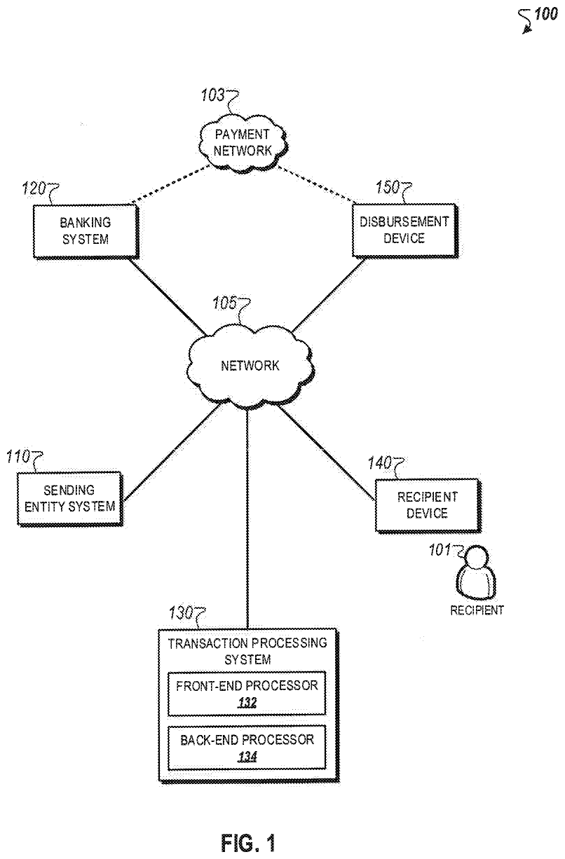

FIG. 1 illustrates an example of an architecture 100 for processing card-less transactions. The architecture 100 includes a sending entity system 110, a banking system 120, a transaction processing system (TPS) 130, a recipient device 140, and a disbursement device 150 that exchange data communications over a network 105. The architecture 100 also includes a payment network 103 through which the banking system 120 and the disbursement device 150 exchange communications relating to transaction authorization and settlement.

The architecture 100 enables a sending entity associated with the sending entity system 110 to disburse funds to a recipient 101. The architecture 100 also enables the recipient 101 to request a disbursement of funds at the disbursement device 150 without the use of a payment card.

The TPS 130 operates as a centralized server that manages various operations involving the sending entity system 110, the banking system 120, recipient device 140, and the disbursement device 150. The operations involved in processing a transaction are discussed in detail below in reference to FIGS. 2A, 2B, 3A-1, 3A-2, 3A-3, and 3B.

The TPS 130 includes a front-end processor 132 and a back-end processor 134. The front-end processor 132 manages communications with the sending entity system 110 and provides an interface for sending entities to, for example, create transaction orders, specify order restrictions, create dynamic order controls, control messages to recipients, among others. In some implementations, the front-end processor 132 operates a portal through which sending entities can configure transaction orders for submission to the TPS 130. For example, the portal can be a web-based online portal that sending entities access through a browser application for configuring and/or managing transaction orders. In other examples, the portal can be configured to operate with one or more application programming interfaces (APIs) that allows an application running on the sending entity system 110 to transmit instructions relating to configuring and/or managing transaction orders to the TPS 130.

The back-end processor 134 manages communications with the banking system 120, the recipient device 140, and the disbursement device 150 and performs operations relating to transaction verification, authorization, and settlement. For example, the back-end processor 134 monitors activity from the eligible disbursement devices 150 to identify a transaction attempt by the recipient 101. The back-end processor 134 identifies transaction information received from the disbursement device 150 and determines whether the information matches verified transaction information received from the front-end processor 132. If a transaction attempt at the disbursement device 150 is verified (i.e., the recipient 101 has been authenticated and determined to be authorized to perform the attempted transaction), then the back-end processor 134 manages transaction disbursement as well as transaction settlement between the banking system 120 and the disbursement device 150.

One example of a transaction is a disbursement request to access funds. The disbursement request is submitted by the recipient 101 at the disbursement device 150. The disbursement request can be made in association with a transaction order submitted by the sending entity system 110 to the TPS 130. For example, the sending entity can submit an order that allows the recipient 101 to access funds from a sending entity funding account managed by the banking system 120 with the transaction being authorized and settled over the payment network 103. The TPS 130 performs all verification and authorization operations to ensure that, for example, the recipient 101 is authorized to perform the requested transaction, the disbursement meets security and other requirements set forth by the banking system 120, and that the disbursement occurs according to any limitations specified by the sending entity in the transaction order sent to the TPS 130. Because the TPS 130 is independently managed and distinct from each of the participating entities of the transaction (e.g., the sending entity, the recipient, the banking system, the manager of the disbursement device), the architecture 100 can be used to allow, for example, a third-party service provider that operates outside of the payment network 103 and banking system 120 to manage transactions without requiring the recipient 101 to use a payment card at the disbursement device 150 to access funds.

A recipient 101 provides credential information at the disbursement device 150 for authentication as an authorized recipient of funds. A sending entity may be interested in disbursing funds to the recipient 101 without the use of payment cards, where the funds may be accessed by the recipient 101 using the disbursement device 150. The sending entity system 110 may be configured to communicate with the recipient 101 through the TPS 130 to the recipient device 140.

The recipient device 140 can be configured to receive data electronically transmitted by the sending entity system 110 for display to the user (e.g., the recipient 101). The recipient device 140 can be any type of computing device suitable for performing functions discussed herein, such as a cellular phone, smart phone, smart watch, laptop computer, notebook computer, tablet computer, wearable computing device, implantable computing device, etc.

The sending entity system 110 can deposit funds intended for the recipient 101 at an issuing institution associated with the banking system 120. The issuing institution can be a financial institution, such as an issuing bank, or other entity that is configured to participate in financial transactions, such as for payment of funds that are disbursed from the disbursement device 150. The deposit of funds at the issuing institution by the sending entity can be accomplished via a payment transaction conducted between the sending entity and the issuing institution. Depending upon the relationship between the sending entity and the issuing institutions, the funds can be deposited in advance of the order creation and disbursement or after the order creation and disbursement. In some implementations, the payment transaction to deposit the funds can be a business-to-business transaction, and/or may be processed via the payment network 103. The payment network 103 can process the payment transaction using traditional methods and systems, such as described in more detail below.

The sending entity can deposit at least the amount intended for disbursement to the recipient 101 at the issuing institution, and may also deposit an additional amount, such as a fee charged by the issuing institution for the service. As a part of the disbursement process, the sending entity system 110 can electronically transmit a pin or code, such as a disbursement code (or secret code), to the recipient device 140 associated with the recipient 101. In some implementations, the code can be sent by the sending entity using a short messaging service (SMS) message, which is transmitted to the recipient device 140 using a suitable communication network, such as a cellular communication network. In other implementations, the code is transmitted using an application program executed by the recipient device 140, such as may be associated with the sending entity. In other implementations, the code can be sent by the sending entity using messaging services or other communication channels. In some instances, the code can be accompanied by an amount of money to be disbursed by the recipient 101 in a card-less disbursement at the disbursement device 150. For instance, in one example, the sending entity may send an SMS message to the recipient device 140 that includes a code of “1294” and a transaction amount of “$140.00” to be disbursed.

In some implementations, the disbursement code may also be electronically transmitted by the disbursement device 150 to the TPS 130 for use in authentication of the recipient 101 that attempts the card-less disbursement at the disbursement device 150. The sending entity can also provide a device identifier associated with the recipient device 140 to the TPS 130. The device identifier may be a unique value associated with the recipient device 140, which may also be used by the TPS 130 for authentication that the recipient 101 attempting the card-less disbursement is the intended recipient of the associated funds. The device identifier may be any suitable type of value, such as a telephone number, e-mail address, username, media access control address, registration number, identification number, serial number, etc. In one example, the device identifier is the telephone number to which the SMS that includes the disbursement code and transaction amount are sent.

In some implementations, the device identifier may be a unique value associated with a specific user of the recipient device 140, such as the recipient 101. For example, the device identifier may differentiate between multiple users of the recipient device 140, such as may occur in areas following natural disasters where access to computing devices or communications are limited. In such examples, the device identifier may be a username, e-mail address, name, social security number or tax identification number (e.g., or part thereof), or other suitable value that may be associated directly with a recipient 101. The device identifier can refer to any identifier that may be used in performing the functions discussed herein including those used for authentication of the recipient device 140 as well as those used in authentication of the recipient 101.

Once the recipient 101 has received the information from the sending entity and TPS 130, the recipient 101 may go to the disbursement device 150 and request a card-less disbursement, such as via a user interface of the disbursement device 150 that is specifically configured by the TPS 130. Once the card-less disbursement is requested, the disbursement device 150 may prompt the recipient 101 for at least the disbursement code, the transaction amount requested, and the device identifier associated with the recipient device 140. The recipient 101 can then input each of the credential information into the disbursement device 150 using one or more suitable input devices. The disbursement device 150 can electronically transmit the inputted data to the TPS 130. The TPS 130 can then authenticate data received at the disbursement device 150 by comparing the data provided by the recipient 101 with the data received from the sending entity system 110 and/or verified data stored at the TPS 130.

Authentication can include, for instance, comparing the disbursement code provided by the sending entity with the code supplied by the recipient 101, to ensure that the recipient 101 entered the correct disbursement code, as would have been transmitted to recipient device 140. The authentication can also include comparing the transaction amount supplied by the recipient 101 with the disbursement amount intended by the sending entity, as well as the device identifier of the recipient device 140. The authentication can also include comparing other information supplied by the recipient 101, such as a transaction identifier generated by the TPS 130 for the order and communicated by the TPS 130 to the recipient 101. Authentication of each of the pieces of data may ensure that the recipient 101 attempting the disbursement is the recipient 101 intended by the sending entity. Once the recipient 101 has been properly authenticated, the TPS 130 can respond to the disbursement device 150 with a confirmation that disbursement is authorized. If authentication of one or more items of data fails, then the TPS 130 can instruct the disbursement device 150 to prevent disbursement, and may provide the disbursement device 150 with a reason, such as may be displayed to the recipient 101. For instance, if the recipient 101 enters the wrong disbursement code, they may be informed so by the disbursement device 150. In some cases, the disbursement device 150 may allow re-entry of data and attempt subsequent authentication. In some such cases, the recipient 101 may be prevented from retrying authentication after a predetermined number of attempts.

If authentication is successful and the disbursement device 150 is authorized by the TPS 130 to make the disbursement, the disbursement device 150 may submit a disbursement request to banking system 120. The banking system 120 may include a financial institution and processor associated with the disbursement device 150, such as an acquiring bank, or other entity configured to process disbursements and other requests that are associated with the banking system 120 for the disbursement, transfer, or other management of currency. The banking system 120 may also include a financial institution and processor associated with the sending entity funding account from which the disbursement will be funded. The banking system 120 may receive the disbursement authorization request from the disbursement device 150, which may include the authenticated transaction amount as well as a payment card number, which may be associated with the transaction account from which the requested amount is to be disbursed.

In some implementations, the banking system 120 provides a payment card number to be used with the disbursement request to the TPS 130 since the recipient does not present a payment card at the disbursement device 150. The TPS 130 passes the payment card number (which, for security purposed, may be encrypted by the TPS 130 and then decrypted by the disbursement device 150) to the disbursement device 150, which then passes the payment card number to the payment network 103 for processing, which may include the comparison by the banking system 120 of the payment card number received by the banking system 120 to the payment card number associated with the funding account held by the banking system 120. If the payment card number is valid, the banking system 120 may approve the transaction and transmit authorization of the disbursement to the disbursement device 150 via the payment network 103. The banking system 120 may then indicate internally that the recipient 101 has successfully obtained their funds. The disbursement device 150 may then dispense the correct amount of funds to the recipient 101.

In some implementations, the banking system 120 may use a controlled payment number for use in the disbursement transaction. A controlled payment number may be a card number that is subject to one or more transaction controls. In such embodiments, the banking system 120 may request, generate, or otherwise identify a controlled payment number for the recipient's transaction, which may be subject to controls on usage (e.g., single use), transaction amount (e.g., to the amount to be disbursed to the recipient 101), and/or other controls that may ensure proper usage of the controlled payment number, such as an expiration date. The controlled payment number may be associated with a funding account by which payment transactions conducted using the controlled payment number are to be funded. In some instances, the banking system 120 may use a single funding account for all card-less disbursements, or for all card-less disbursements for a certain sending entity system 110, or for all card-less disbursements for certain sending entity programs, to which all controlled payment numbers for associated disbursements may be associated.

The controlled payment number may be provided by the banking system 120 to the TPS 130 with the confirmation that disbursement may be requested. The TPS 130 may provide the controlled payment number to the disbursement device 150, which may use the controlled payment number as the payment card number when submitting the transaction message for the payment transaction to the payment network 103. The payment network 103 may then process the payment transaction accordingly.

In some instances, the disbursement request submitted to the payment network 103 may require a personal identification number (PIN), such as due to the use of a specially formatted data message that may require the entry or use of a PIN. In such cases, the disbursement device 150 may use a predetermined value in place of the PIN, which may be ignored or confirmed by the banking system 120 as the predetermined value. In other cases, the TPS 130 may send the disbursement device 150 a PIN for the disbursement device to send to the payment network 103, which PIN may be ignored or confirmed by the banking system 120. In such cases, the recipient 101 may not be required to input a PIN (e.g., as the recipient 101 is already being authenticated by at least three alternative pieces of data), but one may be supplied by the TPS 130 or the disbursement device 150 to ensure successful processing of the request by the payment network 103 and banking system 120. In some instances, the PIN to be used may be supplied by the banking system 120 at the same time as the banking system provides the TPS 130 with the payment card number. Alternatively, the payment network 103 may supply the PIN. In these cases, the payment network 103 may, upon receipt of an authorization request for the disbursement transaction, insert the PIN into a corresponding data element for use by the banking system 120 during the authorization process. In other cases, the recipient 101 may be prompted to input a PIN, but this PIN may be ignored by the banking system 120 for purposes of authorizing the transaction.

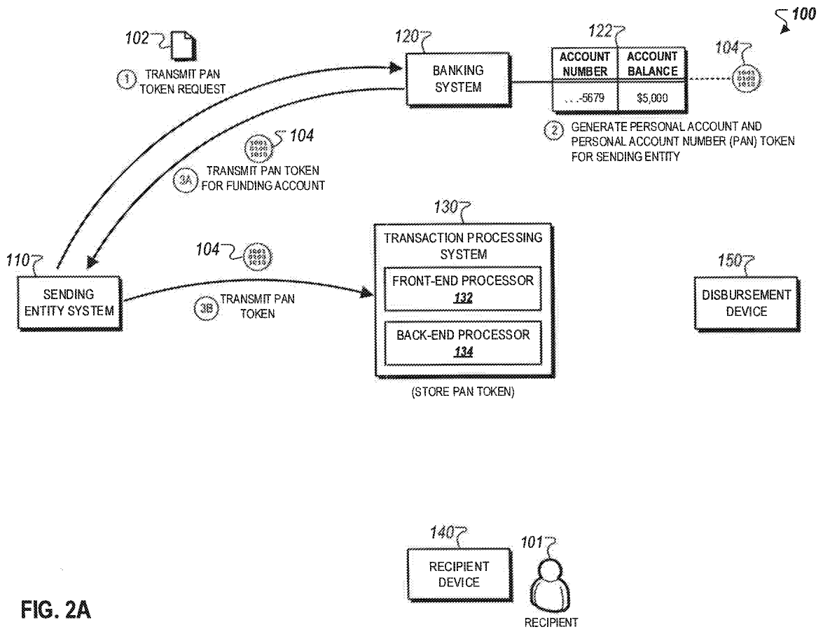

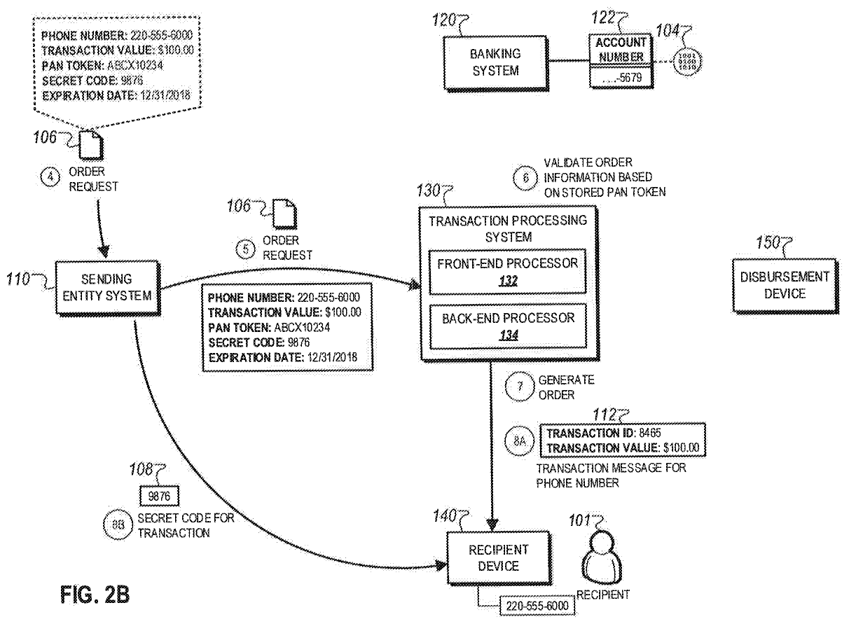

FIGS. 2A and 2B illustrate examples of techniques involved in processing a card-less transaction. Referring initially to FIG. 2A, an example of a registration process between the sending entity system 110 and the banking system 120 and the TPS 130 is depicted.

In stage (1), the sending entity system 110 transmits a PAN token request 102 to the banking system 120. The request 102 can be provided once a financial institution that manages the banking system 120 approves a sending entity for participation in a card-less cash program and the banking system 120 establishes a funding account 122 for the sending entity. The funding account 122 can be a deposit account, a credit account, a commercial account, or other account that is used for funding transaction orders provided by the sending entity.

In stage (2), the banking system 120 generates a PAN token 104 for a funding account 122 of the sending entity. The funding account has an account number identifier at the banking system 120 that is used by the banking system 120 for identification. Since the account number can be used by third parties to initiate transactions to and from the specific funding account, it is important that the account number remain secure and confidential. This is accomplished by generating a PAN token corresponding to the account number of the funding account. The PAN token 104 may be created by the institution that manages the banking system 120 or a third-party service on behalf of the institution. The banking system 120 creates a secure database that associates the PAN token 104 with the funding account identifier. However, since the TPS 130 is managed by a third-party service provider, the TPS 130 does not create the PAN token 104 since, for security purposes, the TPS 130 itself does not have access to the funding account identifier.

In stage (3A), the banking system 120 transmits the PAN token 104 associated with the funding account 122 to the sending entity system 110. In stage (3B), the sending entity system 110 transmits the PAN token 104 as a part of the onboarding process that allows sending entities to use the TPS 130 to submit transaction orders to perform card-less transactions. The TPS 130 stores the PAN token 104 in a database to identify a funding account of a corresponding sending entity. In this way, the TPS 130 uses the PAN token 104 as a way to identify the sending entity funding account 122 without actually accessing or storing the actual identifier for the funding account 122.

In some implementations, the TPS 130 enables the sending entity, if desired, to create an alias or substitute name for PAN token 104 (and the underlying funding account). The sending entity may designate an alias name that is then stored at the TPS 130 and mapped by the TPS 130 to the PAN token 104 to initiate order requests to be drawn from the underlying funding account. As an example, the sending entity can create an alias with the TPS 130 with the name of a particular program for which it is initiating card-less transactions. Then the sending entity can use this alias name to indicate the applicable PAN token 104 and associated funding account 122. Once the PAN Token 104 and/or alias name are stored by the TPS 130, communications between the sending entity system 110 and the TPS 130 that refer to a funding account 122 are identified using the PAN token 104 or an alias name created by the sending entity for the PAN Token.

Referring now to FIG. 2B, an example of a technique for verifying and generating an order for a card-less transaction is depicted. The technique depicted in FIG. 2B can be executed after the technique depicted in FIG. 2A. For example, once a sending entity has registered a funding account with the banking system 120 and registered the PAN token 104 or alias with the TPS 130, the sending entity system 110 can create and submit order requests through a front-end interface of the TPS 130 to allow recipients to access funds from the funding account 122.

In stage (4), the sending entity system 110 receives an order request 106 from a sending entity for a card-less transaction. The order request 106 includes information that identifies a transaction. As shown in FIG. 2B, examples of transaction information include a phone number associated with the recipient device 140, a transaction value, a PAN Token 104, a secret code specified by a sending entity, and an expiration date associated with the transaction order.

In stage (5), the sending entity system 110 transmits the order request 106 to the TPS 130. In stage (6), the TPS 130 validates the order request 106 based on, among other things, a stored PAN token for the funding account 122 of the sending entity. For example, the TPS 130 can compare the PAN token included or identified in the order request 106 to stored PAN tokens to determine if the order request 106 corresponds to a sending entity and funding account that is registered with the TPS 130. The TPS 130 can determine that the order request 106 is valid if a stored PAN token matches the PAN token that is included with, or identified in, the order request 106. This validation ensures that the received order request 106 is truly submitted by a sending entity that has registered to participate in a card-less transaction program with the banking system 120 and that the sending entity is using a valid funding account 122.

In stage (7), the TPS 130 generates an order for the card-less transaction specified by the order request 106. In stage (8A), the TPS 130 generates transaction information 112 for the order. The transaction information 112 identifies the order request 106 submitted by the sending entity system 110, including, for example, a transaction identifier and a transaction value. The TPS 130 provides a communication including the transaction information 112 to a phone number of the recipient device 140 that is identified in the order request 106.

In stage (8B), in parallel with the communication provided by the TPS 130, the sending entity system 110 also provides a communication to, for example, the phone number of the recipient device 140 that is identified in the order request 106. This communication includes a secret code 108 that is only known to the sending entity system 110 and the TPS 130. In this way, the recipient device 140 receives one communication from the sending entity with the secret code 108, and another communication from the TPS 130 that includes the transaction information 112. Thus, only the TPS 130 and the recipient 101 have access to both the secret code 108 and the transaction information 112, both of which are required credentials to authorize a disbursement transaction. For security purposes and to make it harder for a recipient to claim that someone else made an unauthorized disbursement of an order, none of the sending entity, sending entity system 110 or banking system 120 have access to all of this information. As discussed below, the information included in these communications are then used for authentication of the recipient 101 when he/she attempts to access funds from the disbursement device 150 in relation to the order. As an additional security measure, the transaction identifier that is automatically generated by the TPS 130 for each order and communicated by the TPS 130 to the recipient 101 is not visible or accessible to anyone else, including system administrators that operate the TPS 130. The TPS 130 automatically generates the transaction identifier and stores this credential in a secure database that cannot be accessed by TPS 130 personnel. When the credentials associated with a disbursement request are received, the TPS 130 can access this database to verify the transaction identifier match without requiring access to the database. Access to the database is thereby restricted. Thus, the recipient 101 is truly the only person with access to all of the credentials required to obtain the disbursement of a particular order. This provides enhanced security for the transaction while also making it harder for a recipient 101 to repudiate a transaction after the disbursement has been made.

FIGS. 3A-1, 3A-2, and 3A-3 illustrate an example of a transaction settlement technique that uses a VCN to settle a card-less transaction. In this example, the VCN is used to perform authorization and settlement for card-less transactions by using the disbursement device 150 to exchange communications with the payment network 103 and banking system 120.

As discussed below, a VCN token 119 corresponding to the VCN 118 is generated by the banking system 120 and stored by the TPS 130 in lieu of the VCN 118 that is associated with the funding account 122. This technique can be used to minimize risk exposure to the sending entity and/or the banking system 120 since the TPS 130 is managed by a third-party service provider. By having the TPS 130 store the VCN token (instead of the VCN itself) associated with the particular order while waiting for the recipient 101 to input credentials at an eligible disbursement device 150, this minimizes the possibility of unauthorized access to VCNs if the TPS 130 becomes compromised.

The techniques depicted in FIGS. 3A-1, 3A-2, and 3A-3 are executed after the technique depicted in FIG. 2B. For example, once the TPS 130 has verified an order request for a card-less transaction, the TPS 130 generates the order and sends the transaction credentials to the recipient 101. Then the TPS 130 waits to be contacted by a disbursement device 150 when the recipient seeks to obtain a disbursement using his/her transaction credentials.

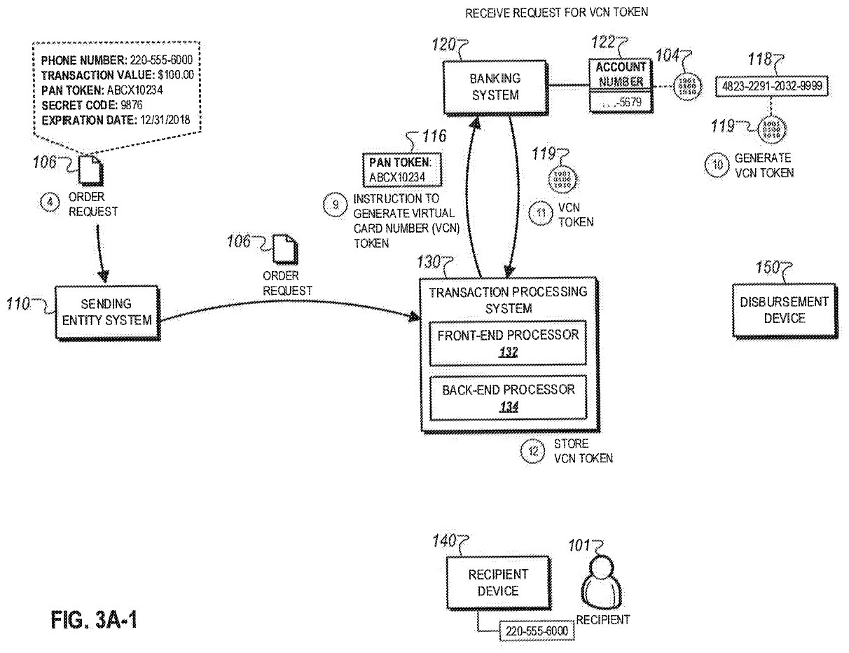

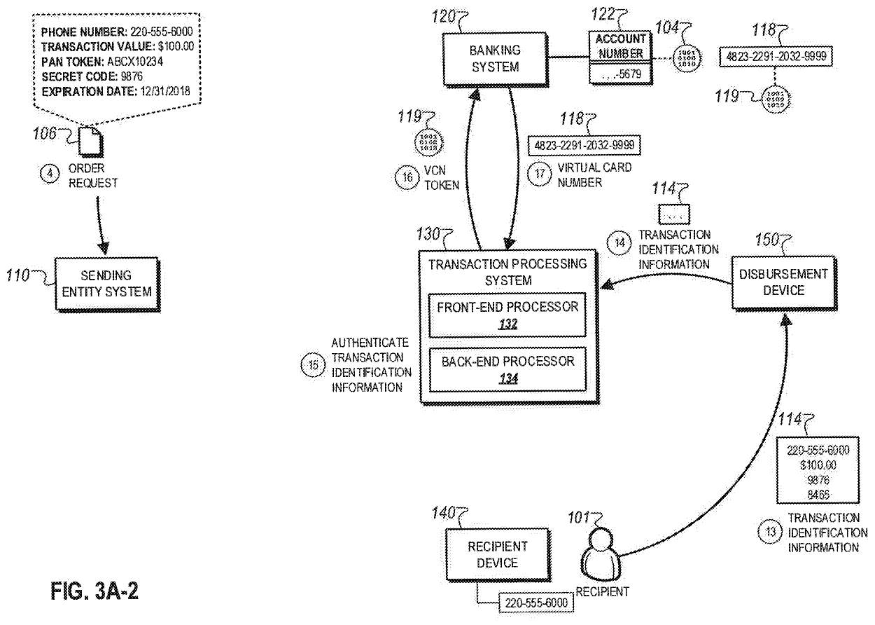

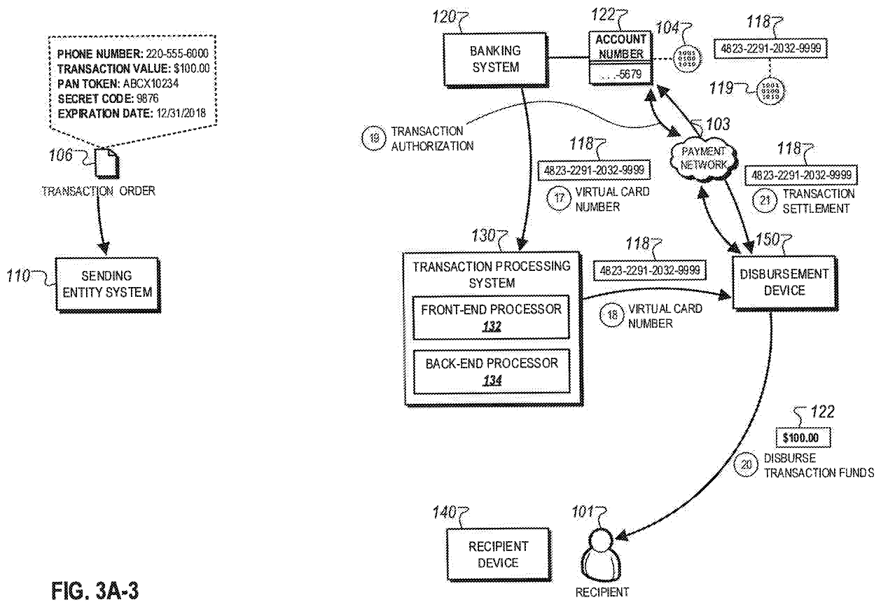

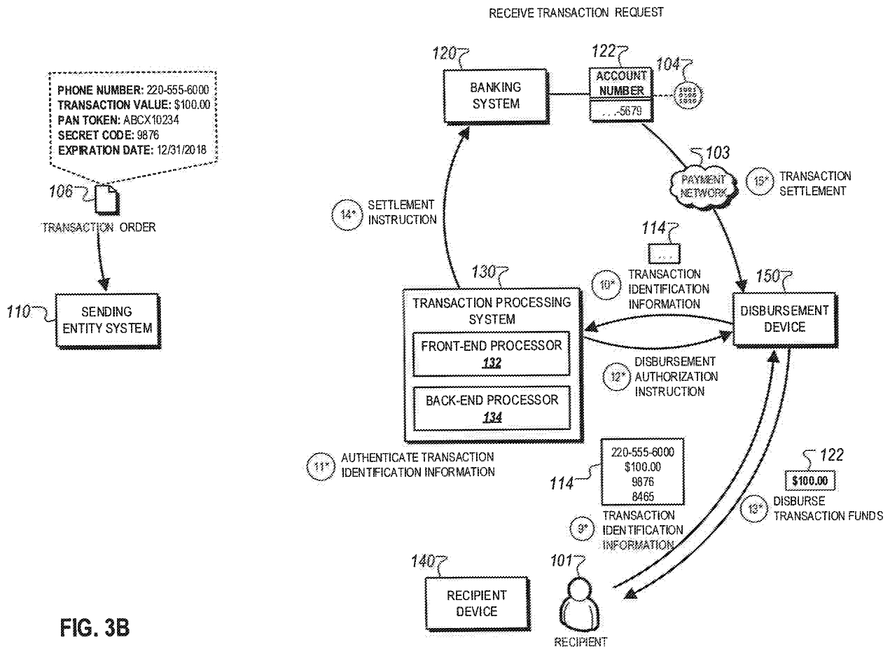

Referring initially to FIG. 3A-1, in stage (9), the TPS 130 transmits an instruction 116 to generate a VCN 118 to the banking system 120. The instruction 116 includes the PAN token 104 to identify the funding account for which the VCN 118 should be created. The instruction 116 causes the banking system 120 (or a third-party system authorized by an issuing institution) to create a VCN 118 for an order amount specified by the order request 106 and to associate the VCN 118 with the funding account 122 of the sending entity. The banking system 120 associates each newly created VCN to the applicable funding account. Once created, the banking system 120 generates a database mapping to associate the VCN 118 and the funding account 122.

In stage (10), the banking system 120 generates a VCN token 119 that is associated with a VCN 118 generated for the order and associated with the funding account 122. The banking system 120 (or a third-party service provides) generates the VCN Token 119 to uniquely identify the VCN 118. The VCN token 119 is included in the database mapping that associates the VCN 118 and the funding account 122. In this way, the VCN token 119 can be used to identify specific transactions associated with the funding account 122 without requiring storage of the VCN 118 in an external system, such as the TPS 130.

In stage (11), the banking system 120 transmits the VCN token 119 to the TPS 130 and the TPS 130 stores the VCN token 119 in stage (12) while also associating the VCN Token 119 with the transaction identification information 114 for the requested order. The tokenized approach discussed above permits the TPS 130 to store the PAN Token 104 in lieu of the account number of the funding account 122 and store the VCN Token 119 in lieu of the VCN 118. This feature improves transaction security overall, and enables a third-party service provider that is independent and distinct from the issuing institution to manage transactions with accounts of the banking system 120.

Referring now to FIG. 3A-2, a transaction authorization procedure is depicted. The transaction authorization procedure enables the TPS 130 to authenticate the recipient 101 and permit the disbursement of funds in accordance with the order request 106 specified by the sending entity through the disbursement device 150. As discussed above, this procedure can be used by the TPS 130 to process orders and disbursements according to security requirements of the banking system 120.

In stage (13), the recipient 101 submits transaction identification information 114 at the disbursement device 150. The disbursement device 150 can be one of a set of eligible disbursement devices that are associated with the TPS 130. For example, the disbursement device 150 can be managed by an entity that participates in the card-less transaction program and permits, for example, the TPS 130 to access data processed by the disbursement device 150, configure software running on the disbursement device 150, or provide executable instructions that cause the disbursement device 150 to perform operations responsive to the instructions, such as disbursing funds in response to receiving a disbursement request from the recipient 101.

In stage (14), the TPS 130 detects the recipient 101's access to the disbursement device 150 and obtains transaction identification information 114 submitted by the recipient 101 at the disbursement device 150. As shown, the transaction identification information 114 includes the phone number associated with the recipient device 140, a transaction identifier, a transaction amount, and a secret code. This information, if accurate and valid, should match the transaction information 112 (shown in FIG. 2B) included in the communication provided by the TPS 130 to the recipient device 140 and the secret code 108 (shown in FIG. 2B) included in the communication provided by the sending entity system 110 to the recipient device 140. The TPS 130 therefore evaluates the transaction identification information 114 for user authentication and transaction verification.

In stage (15), the TPS 130 authenticates the transaction identification information 114 based on stored order information. The TPS 130 determines that the recipient's disbursement request at the disbursement device 150 is authenticated if the transaction identification information 114 matches the order information stored at the TPS 130. Alternatively, if the information does not match the stored transaction information, the TPS 130 can instruct the disbursement device 150 to deny disbursement or request additional information.

In stage (16), if the TPS 130 has successfully authenticated the transaction identification information 114 received from the disbursement device 150, then the TPS 130 transmits the stored VCN token 119 associated with the transaction identification information 114 to the banking system 120 to request the VCN 118 for the transaction order 106 from the banking system 120. The banking system 120 uses the VCN Token 119 to identify the VCN 118 from a record in an associated database that maps the VCN 118 and the VCN token 119, as discussed above in reference to FIG. 3A-1. In stage (17), the TPS 130 obtains the VCN 118 corresponding to the VCN token 119 from the banking system 120.

Referring now to FIG. 3A-3, a transaction authorization and settlement procedure is depicted. The transaction authorization and settlement procedure enables the TPS 130 to manage authorization and settlement between the banking system 120 and the disbursement device 150 corresponding to the disbursement of funds at the disbursement device 150. Transaction authorization and settlement is accomplished using the VCN 118, which is temporarily accessed by the TPS 130 and provided to the disbursement device 150. In some implementations, for security purposes, the VCN 118 is encrypted by the TPS 130 before transmission to the disbursement device 150 and then decrypted by the disbursement device 150. As discussed above, the TPS 130 only accesses the VCN 118 periodically for the purpose to carrying out transaction authorization and settlement but does not store the VCN 118 for extended time periods. Once transaction authorization and settlement has completed, the TPS 130 deletes any instances of, and/or references to the VCN 118 at the TPS 130. Instead, the TPS 130 stores the VCN token 119 in its transaction records.

In stage (18), the TPS 130 transmits the VCN 118 to the disbursement device 150. In stages (18 and 21), the disbursement device 150 is also configured to disburse transaction funds specified by the card-less transaction to the recipient 101. The TPS 130 can use different techniques for configuring the disbursement device 150. In some implementations, the TPS 130 transmits executable code to the disbursement device 150 that, when received by the TPS 130, causes the TPS 130 perform operations specified by the executable code. In these implementations, the disbursement device 150 is dynamically configurable based on the transaction to be performed at the disbursement device 150. In other implementations, the disbursement device 150 is pre-configured prior to transaction authorization to run software that enables the disbursement device 150 to perform operations associated with transaction authorization.

In stage (19), the disbursement device 150 performs transaction authorization with the banking system 120 over the payment network 105 using the VCN 118 received from the TPS 130. The disbursement device 150 transmits the VCN 118 over the payment network 105 for transaction authorization. When the banking system 120 receives the VCN 118 from the disbursement device 150, the banking system 120 accesses its database to identify the funding account 122 to confirm the validity of the VCN 118 and that there are sufficient balances and/or credit availability to authorize, clear and settle the transaction. Assuming the VCN 118 is valid and there are sufficient balances or availability in the funding account 122, the banking system 120 will authorize the transaction and respond to the disbursement device 150 to permit the disbursement in stage (20). Following the successful disbursement, in stage (21) the banking system 120 and the service provider for the disbursement device will clear and settle the funds for the transaction from the funding account 122 via the payment network 105.

FIG. 3B illustrates an example of a transaction settlement technique that can be used to process a card-less transaction without a VCN. The transaction settlement technique depicted in FIG. 3B is performed without the use of a VCN and associated VCN token as depicted in the transaction settlement procedure shown in FIGS. 3A-1, 3A-2, and 3A-3. In this example, the TPS 130 manages transaction authorization and directs the banking system 120 to perform transaction settlement with the disbursement device 150 over the payment network 103 (as opposed to the banking system 120 performing transaction authorization and settlement as discussed above in reference to FIGS. 3A-1, 3A-2, and 3A-3). In this manner, the TPS 130 determines whether the recipient 101 has been authorized to be disbursed funds from the funding account 122 instead of the banking system 120, directs the disbursement device 150 to disburse the funds and directs the settlement of the funds without the use of a VCN. Thus, the technique depicted in FIG. 3B can be performed as an alternative type of transaction authorization and settlement to the technique depicted in FIGS. 3A-1, 3A-2, and 3A-3.

In stage (9*), the recipient 101 submits transaction identification information 114 at the disbursement device 150 in a similar manner as discussed above for step (13) in FIG. 3A-2. In stage (10*), the TPS 130 detects the recipient 101's access to the disbursement device 150 and obtains the transaction identification information 114 submitted by the recipient 101 at the disbursement device 150. This step is performed in a similar manner as discussed above for step (14) in FIG. 3A-2. In stage (11*), the TPS 130 authenticates the transaction identification information 114 based on stored order information in a similar manner as discussed above for step (15) in FIG. 3A-2. In stage (12*), the TPS 130 provides a disbursement authorization instruction to the disbursement device 150 based on authenticating the transaction identification information. In stage (13*), once transaction disbursement has been authorized by the TPS 130, the disbursement device 150 is configured to disburse transaction funds specified by the card-less transaction to the recipient 101 in a similar manner as discussed above for step (20) in FIG. 3A-3.

In stage (14*), the TPS 130 transmits a settlement instruction to the banking system 120 that configures the banking system 120 to initiate transaction settlement for the card-less transaction. In stage (15*), the disbursement device 150 (or the service provider managing the disbursement device) performs transaction settlement with the banking system 120 over the payment network 103. The TPS 130, in this example, may confirm the availability of funds in the funding account 122 at the time of receipt of the transaction identification information 114 from the disbursement device 150. If sufficient funds are available, the TPS 130 authorizes the disbursement of the funds by the disbursement device 150. The TPS 130 then also manages the settlement of the funds between a sending entity and a service provider of the disbursement device 150 by directing the banking system 120 to move funds from the funding account 122 to the designated account for the service provider (which may be also be an account of the owner of the disbursement device 150).

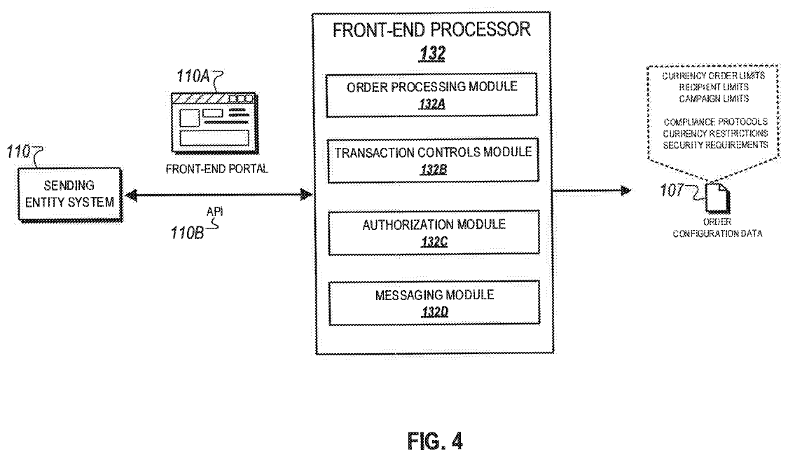

FIG. 4 illustrates an example of the front-end processor 132. As discussed above, the front-end processor 132 manages communications with the sending entity system 110 and provides a front-end portal 110A through which a sending entity can perform various operations. As examples, the sending entity can use the front-end portal 110A to create transaction orders, specify order restrictions, create dynamic order controls, cancel orders, among others. In some implementations, the front-end portal 110A is generated as a web-based online portal that the sending entity accesses through a browser application for configuring and/or managing transaction orders on the sending entity system 110. In other implementations, the front-end portal 110A can be configured to operate with one or more APIs 1106 that allow an application running on the sending entity system 110 to transmit instructions relating to configuring and/or managing transaction orders to the TPS 130.

The front-end processor 132 includes software modules that operate with the front-end portal 110A to provide the functionality described herein for the front-end processor 132. The front-end processor 132 includes an order processing module 132A, a transaction controls module 132B, an authorization module 132C, and a messaging module 132D.

The order processing module 132A exchanges data communications with the sending entity system 110 to support viewing, adding, updating and cancellation of transaction orders. For example, the order processing module 132A can manage transaction orders that have been submitted by a sending entity and process input submitted by the sending entity through the front-end portal 110A. The order processing module 132A can also manage order records, display screens and reports that identify information for submitted transaction orders, such as order status (e.g., pending, disbursed, expired, etc.), payment status, transaction identification information (e.g., transaction identifier, order amount, secret code, recipient phone number, etc.), among others.

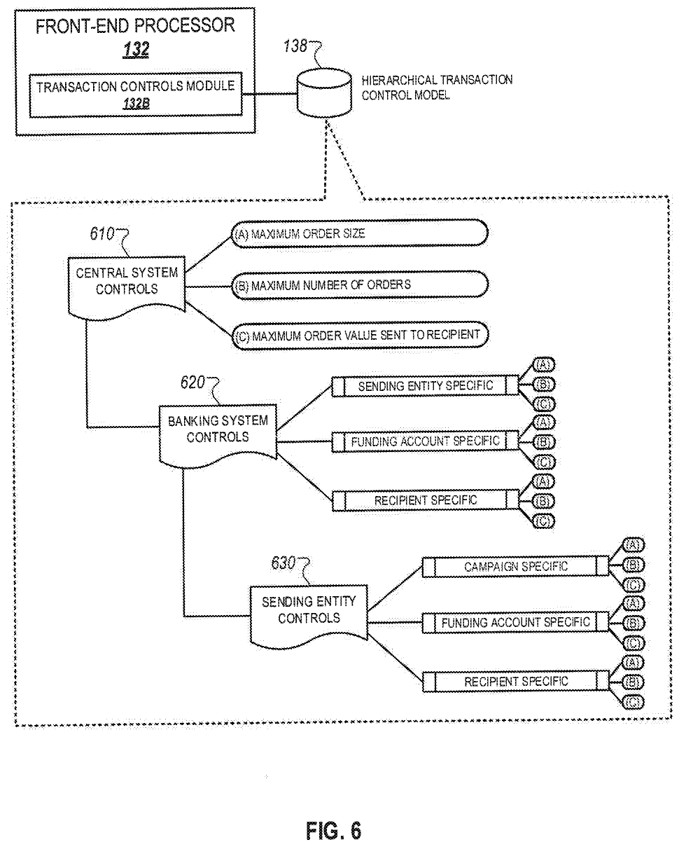

The transaction controls module 132B manages different types of controls that are associated with transaction orders processed by the front-end processor 132. Examples of such controls include sending entity controls, PAN controls, campaign controls, and recipient controls. In some implementations, the transaction controls module 132B provides a system administrator associated with the front-end processor 132 as well as administrators for the issuing banks and sending entities with the ability to create entity-specific, recipient-specific, bank-specific or funding-account specific controls that are implemented on the front-end portal that a sending entity or issuing bank uses to access the front-end processor 132. Transaction controls are discussed in more detail below in reference to FIG. 6.

The authorization module 132C manages the registration and verification of issuing banks and sending entities that access the front-end processor 132 through the front-end portal 110A and APIs 110B. For example, during an initial registration process, the authorization module 132C can communicate with the sending entity system 110 or the banking system 120 to receive and store a PAN token that is assigned to a funding account of a new sending entity at the banking system 120. The authorization module 132C can use the stored PAN token to determine if it matches a PAN token included in an order request. The authorization model 132C also manages the access entitlements for the authorized users of the issuing banks and the sending entities to restrict the ability to modify settings, submit orders and view certain data to only the intended users for each of the issuing banks and sending entities.

The messaging module 132D generates, transmits, and manages communications with recipient devices that are associated with sending entity order requests received by the order processing module 132A. For example, the messaging module 132D can control the formatting and content of communications to be provided to recipient devices using communication templates that identify transaction information fields to be included in the communication. In some implementations, templates can be used to generate communications for different types of recipients and/or transaction orders. For example, a first communication template can be used for an order representing the disbursement of an incentive between a sending entity company and a recipient individual, a second communication template can be used for an order representing a money transfer between an individual sender and an individual recipient and a third communication template can be used for an order representing an emergency fund disbursement order by a credit card issuer to a cardholder who has lost his/her wallet, etc.

In some implementations, the messaging module 132D is integrated with various order communication services to enable the front-end processor 132 to communicate with order recipients using different communication channels (e.g., SMS text, email, a mobile application, a messaging application, a social media network, etc.). Order credentials sent by the front-end processor 132 to an order recipient can be consistent regardless of the communication channel used to transmit the order credentials.

After processing an order request, the front-end processor 132 generates order configuration data 107. The order configuration data 107 identify different aspects of an order, such as transaction limits (e.g., currency order limits), recipient limits, campaign limits, transaction protocols (e.g., compliance protocols), transaction restrictions (e.g., currency restrictions), or transaction requirements (e.g., security requirements). In some instances, the information specified in the transaction order 106 is specified by a sending entity through the front-end portal 110A. In such instances, the sending entity is provided with sufficient privileges to access and control configuration data managed by the front-end processor 132. In other instances, the information specified in the order configuration data 107 is specified by a system administrator associated with the issuing bank or front-end processor 132.

In some implementations, the front-end processor 132 can be configured to send different types of messages to recipients at different time points in the card-less transaction disbursement process. The messages can be processed by the messaging module 132D. For example, messages triggered by the occurrence or non-occurrence of certain events relating to a card-less cash transaction (e.g., time from order receipt, time from opening of order or other message by intended recipient, time until order expiration, actual cash disbursement, etc.). In other examples, messages can be sent based upon the visibility into events provided by the TPS 130. In some instances, messages relate to the order itself, such as a reminder to redeem the order prior to the expiration date or a thank you after disbursement of the order or even an extension of the order expiration date. In other instances, messages are unrelated to the order itself, such as a new follow up offer to the recipient a certain number of days after redemption of the original order. Messages can be manually configured by sending entities through the front-end portal, or alternatively, configured by the messaging module 132D as automatically triggered messages. In some implementations, the front-end processor 132 provides sending entities with the ability to use the front-end portal 110A to view a real-time status of a recipient's order and the ability to intervene in the process to send ad hoc messages as additions to or replacements for other messages. In some implementations, messages can be configured to be sent to parties other than the order recipient such as a notification to a sender of a money transfer order when an order has been sent to a recipient or when the recipient has been disbursed the funds.

In some implementations, the front-end processor 132 can use location tracking techniques (e.g., geolocation tracking, beacon-based connection events, geofencing, etc.) to use a recipient's location as a factor in triggering messages to the recipient. For example, the front-end processor 132 can enable a sending entity to elect to send the recipient an automatic reminder message if the recipient has an open (e.g., unredeemed and unexpired) order and is in proximity to, for instance, a disbursement device 150, the sending entity's location, or some another location of interest. As another example, the sending entity may elect to use the recipient's location to automatically send the recipient a different message which may or may not be dependent upon the status of a prior order to the recipient. In this example, the sending entity may elect to send a prior order recipient a promotional or marketing message if the recipient is near a retail location, regardless of the status of the prior order.

The front-end processor 132 can also allow sending entities to elect to send certain messages via alternative communication channels, if desired, as opposed to using the same communication method for all interactions. For example, messages that communicate immediate action to be performed by a user can be transmitted over SMS text, whereas messages that include receipts for executed transactions can be transmitted over email or via a messaging service. In some implementations, sending entities can customize messaging preferences through the front-end portal 110A.

In some instances, the front-end processor 132 can provide follow-up communications to a recipient using the messaging module 132D. The follow-up communications can be provided through the same communication channel as the primary message (e.g., sending a follow-up text from the same sender text number so that it is displayed in the same text conversation as the primary message). Alternatively, the follow-up messages can be provided through a different communication channel if a recipient becomes unreachable after a primary message has been sent (e.g., sending a follow-up email if the recipient changes phones and has a new phone number after the primary number is sent). The front-end processor 132 can also enable the sending entity to send messages that prompt a response from the recipient using the same communication channel and/or conversation (e.g., “Reply with 1 to 5 with 5 being the highest to indicate your satisfaction with your purchase” or “Reply with 1 to receive a phone call from one of our agents”). The front-end processor 132 can receive and store responses in a database and make them available to the sending entities through the front-end portal 110A or the API 110B so that further action can be taken based upon the responses. The front-end processor 132 can also provide additional automated responses to these intended recipient responses (e.g., a thank you message if the consumer responds to a message prompt).

In addition to enabling sending entities to set up customized messages and triggers for programs, the front-end processor 132 can also enable sending entities to associate messages and trigger rules with campaigns hosted by the sending entities. As described herein a campaign can be a program (or sub-program) that is operated by a sending entity that wants to set up and track orders and data associated with the specific program. For example, a campaign can be a rewards program that provides incentives to consumers for taking certain specified actions (e.g., buying 4 new tires). A sending entity can configure a campaign with a particular set of messages and triggers for all orders associated with that campaign. In this way, at the time of order submission, the sending entity can associate the order with an identifier for the applicable campaign and the order will automatically be configured with the messages and triggers set for the overall campaign. This reduces the complexity associated with configuring orders through the front-end portal 110A or the API 110B since the sending entity need not individually configure messages and triggers for each individual order. This also provides the ability to generate reports to track criteria specific to the applicable campaign.

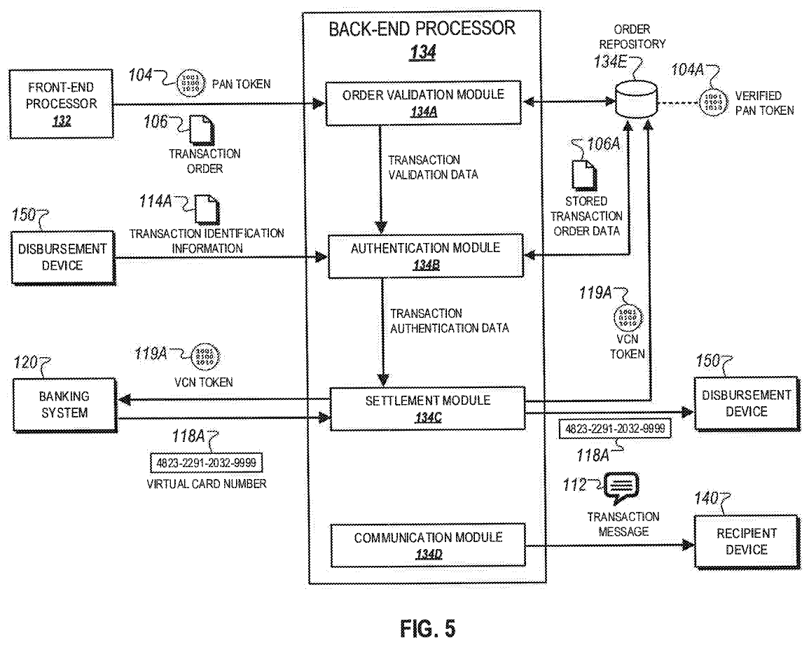

FIG. 5 illustrates an example of the back-end processor 134. As discussed above, the back-end processor 134 manages communications with the banking system 120, the recipient device 140, and the disbursement device 150 and performs operations relating to transaction verification, authorization, and settlement. As shown in FIG. 5, the back-end processor 134 performs various operations to ensure that a transaction order 106 is valid, recipient is authorized to perform a transaction specified by the transaction order 106, and settle the transaction between the banking system 120 and the disbursement device 150.

The back-end processor 134 includes software modules that provide the functionality described herein for the back-end processor 134. The back-end processor 134 includes an order validation module, an authentication module 134B, a settlement module 134C, and a communication module 134D.

In the example depicted in FIG. 5, the order validation module 134A initially receives the transaction order 106 and an associated PAN token 104A from the front-end processor 132. The order validation module 134A determines whether the PAN token 104A matches a verified PAN token 104A stored in an order repository 134E, which was added during an initial registration process depicted in FIG. 2A. The order validation module 134A generates transaction validation data based on the comparison. For example, the order validation module 134A determines that the transaction order 106 is valid if, among other things, the PAN token 104A matches the verified PAN token 104A.

Once the transaction order 106 has been validated, the communication module 134D provides a transaction message 112 to the recipient device 140 in association with the validated transaction order. The transaction message 112 includes credential information that is used to authenticate the recipient at the disbursement device 150. For example, as discussed above, the transaction message 112 can include a transaction identifier and a transaction amount that is uniquely specified by the transaction order 106. The recipient submits the information within the transaction message 112 at the disbursement device 150 for transaction authentication, as discussed below.

The authentication module 134B receives transaction identification information 114A submitted by a recipient at the disbursement device 150. The authentication module 134B evaluates the transaction identification information 114A to authenticate the recipient and/or determine whether the transaction is authorized for processing. The authentication module 134B compares the transaction identification information 114A and transaction order data 106A stored in the order repository 134E to determine if the two match. For example, the authentication module 134B determines whether there is a matching phone number, a transaction amount, a transaction identifier, and a secret code between the transaction identification information 114A and the transaction order data 106A. The authentication module 134B generates transaction authentication data based on the comparison. For example, if the transaction identification information 114A matches the transaction information within the transaction order data 106A, then the authentication module 134B determines that the recipient's transaction attempt at the disbursement device 150 is verified.

Once the transaction has been authenticated, the settlement module 134C transmits the VCN token 119A to the banking system 120. As discussed above in reference to FIGS. 3A-1, 3A-2, and 3A-3, the VCN can be used for transaction settlement over a payment network associated with the banking system 120. The settlement module 134C sends the associated VCN Token 119A to the banking system 120 and the banking system 120 retrieves and returns to the settlement module 134C the corresponding VCN 118A. The settlement module 134C forwards the VCN 118A to the disbursement device 150 for authorization and settlement, and stores the VCN token 119A in the order repository 134E. The settlement module 134C momentarily stores the VCN 118A for authorization and settlement purposes only and does not store the VCN 118A in the order repository 134E. For example, once the settlement module 134C receives an indication from the disbursement device 150 that disbursement was successfully performed, the settlement module 134C deletes data referencing the VCN 118A so that only the VCN token 119A is identifiable in the order repository 134E.

FIG. 6 illustrates an example of a hierarchical transaction control model 138 that can be applied in processing card-less transactions with different types of entities. In this example, the transaction control model 138 is maintained by the transaction controls module 132B and used to provide the TPS 130, the issuing bank and the sending entities with the ability to create different types of controls and limits for transaction orders through, for example, the front-end portal 110A and API 110B. The purpose of these controls is to allow the various participants to further mitigate the risks and enhance the security of their card-less transaction programs.

The transaction control model 138 provides participating entities (e.g., a system administrator of the TPS 130, an issuing institution of the banking system 120, and a sending entity of the sending entity system 110) with access to various customizable order limits and controls. The controls can be configured prior to the submission of orders by sending entities through the front-end portal 110A. In some instances, the controls can also be configured and/or modified at any time after a sending entity submits a transaction order and applied to subsequently submitted transaction orders.

The transaction control model 138 is hierarchically structured to provide different levels of controls, and a set of control parameters for each hierarchical level. System-wide controls are set by the system administrator for the TPS 130 and provide the highest level of the hierarchy, followed by the issuing bank-level controls and then the sending entity-level controls. In some instances, not all controls are available to (or applicable to) all participating entities. Where a control is available to more than one entity, the entity in the lower hierarchy is instructed by the system to set limits to be no less restrictive than the higher entities. This is accomplished by having the lower hierarchy control automatically “inherit” any higher hierarchy settings for the same control. The transaction controls module 132B then prevents the lower hierarchy entity from changing a control unless the change is more restrictive than the higher entity setting.

The transaction controls module 132B evaluates each transaction order as it is received against controls specified in the transaction control model 138 for such order. If an inheritance-type model is being applied, then the transaction controls module 132B evaluates only the lowest level of each control. Alternatively, if this type of model is not being used, the transaction controls module 132B evaluates controls starting with the higher entity controls and then moving down the hierarchy to the lower entity controls.

For limits that are aggregates (e.g., total order volume fora day fora sending entity), the transaction controls module 132B operates “counters” that accumulate relevant data for each applicable transaction order and rejects any transaction order that exceeds the applicable limit. The “counters” can also be reset upon the expiration of an applicable time period (e.g., the daily limit counters restart at zero on the following day).

The transaction controls module 132B can receive data inputs from external data sources to set certain of the controls. For example, the transaction controls module 132B can receive periodic or real-time account balance updates from the banking system 120 for a particular sending entity to ensure there are sufficient funds available to cover any new order requests. In the example of the account balance control, the transaction controls module 132B can also adjust the “open-to-buy” of a sending entity based upon the most recent funding account balance received from the banking system 120 and actual system order information, such as any subsequent orders issued, expired or canceled in relation to the applicable funding account.

For certain controls, the transaction controls module 132B allows the aggregation of transactions across all participating sending entities. For example, for anti-money laundering purposes, it may be important to track and control all orders being sent to a particular recipient by all sending entities across the entire system. This can be accomplished by applying a system-wide control that limits the number and value of transactions that can be sent to a particular recipient during specific timeframes.

In FIG. 6, the transaction control model 138 includes three control levels. Control level 610 identifies control parameters that are applied across the TPS 130, which has the broadest applicability since they can be applied to all transactions that are processed by the TPS 130. Examples of control parameters at this level include maximum order size and maximum number of orders and order value sent to a single recipient within a specified time frame. These control parameters can be used to impose system-wide limitations for all sending entities that are associated with the TPS 130. For instance, the maximum number of orders can be set to 10 orders or $2,000 during any month to limit the monthly order volume of all sending entities to any particular recipient.

Control level 620 identifies control parameters that are applied to a given banking system that is registered with the TPS 130. These control parameters are applicable to a subset of transaction orders that are processed by the TPS 130, namely the orders issued by a particular issuing financial institution. Examples of control parameters at this level include controls set by the issuing bank that are applied to a particular sending entity, controls that are applied to a specific funding account at the banking system 120, or controls that are applied to a specific recipient. These controls can be used to apply specific controls from among different types of transaction orders. For example, entity-specific controls can be used to create a different maximum transaction order value between a first sending entity that is providing corporate incentives versus a second entity that is providing consumer money transfers. As another example, funding account-specific controls can be used to create different maximum orders between a first funding account for a particular type of program and a second funding account for a different type of program. In this way, the control level 620 provides an issuing institution with the ability to customize the transaction order controls for different sending entities, funding accounts, and recipients.

Control level 630 identifies control parameters that are available to a given sending entity that is registered with the TPS 130. These control parameters are applicable to a subset of transaction orders that are processed by the TPS 130 that correspond to the given sending entity. The sending entity controls include the ability for the sending entity to set up specific controls and limits for subsets of its program such as for different funding accounts and different campaigns (e.g., a tire rebate vs. an electronics rebate). The sending entity can also set its own limits for specific recipients.

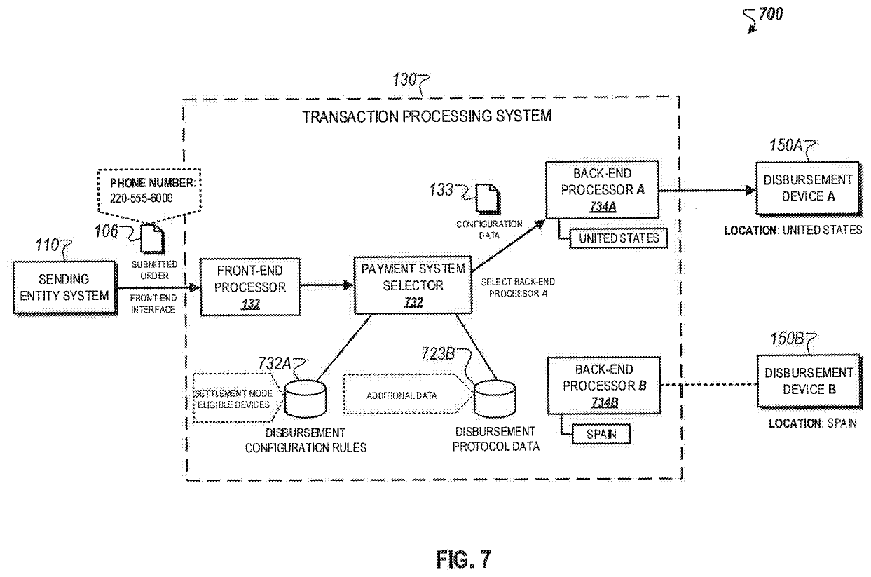

FIG. 7 illustrates an example of card-less transaction system 700 that can process transactions originating from multiple countries. In this example, the TPS 130 includes a front-end processor 132, a payment system selector 732, and multiple back-end processors 734A and 734B for different localities in which card-less transactions are to be disbursed. The back-end processors 734A and 734B exchange communications with disbursement devices 150A and 150B, respectively, which are located in two different localities (e.g., United States and Spain).

In general, the system 700 can provide flexibility to comply with legal, regulatory and other requirements for card-less transactions in, for example, different countries with different (or even contradictory) transaction requirements. To ensure compliance with local regulations, the system 700 includes a payment system selector 732 that stores disbursement configuration rules 732A and disbursement protocol data 732B, which each includes several fields that can be used for disbursements in a particular country. The system 700 is also integrated with various order communication services that enable the TPS 130 to communicate with order recipients using various methods (e.g., SMS text, email, mobile application, messaging applications, social media, etc.). The system 700 also includes the ability to configure the interactions and communications between the participants in the appropriate language for the recipient 101 and disbursement device 150. The core order credentials sent by the central system to the order recipient 101 are typically consistent regardless of the communication channel and language used.

The payment system selector 732 enables connectivity and integration with disparate disbursement platforms, through the use of multiple back-end processors, e.g., back-end processors 734A and 734B. The multiple back-end processors are capable of exchanging communications with disbursement devices 150A and 150B, which can represent, without limitation, a set of individual ATMs, ATM processors, ATM switches, point-of sale (POS) systems, POS processors, kiosks, customer service terminals, in different countries and configured to disburse currencies with different technological protocols.

Disbursement devices 150A and 150B are configured to use different methods, processes and protocols to communicate with the TPS 130 (e.g., different communication protocols, authentication protocols, transaction settlement protocols). As discussed below, to simplify this complexity from the perspective of a sending entity as well as a payment processor, the TPS 130 uses a single front-end processor 132 to enable a sending entity to use a single transaction processing platform (e.g., the TPS 130) to manage transactions involving different countries. This approach also simplifies the requirements for the issuing banks which also only need to interact with a single front-end processor 132 and processing system (e.g., the TPS 130).

The disbursement configuration rules 732A identify specific requirements for integrating with, connecting with and operating with each participating disbursement device 150A and 150B and provides central integration, interface and connectivity with each participating disbursement platform/machine on behalf of sending entities. The disbursement protocol data 732B includes data that identifies requirements for communication methods, formats and protocols for delivering orders to recipients intended to be redeemed at a particular disbursement device. The disbursement protocol data 732B can also identify communication methods, formats and protocols for verifying the identity of disbursement devices, communication methods, formats and protocols for receiving and authenticating credentials and disbursing orders at each disbursement device, and authorizing and settling transactions for each disbursement device.

A sending entity transmits order information to the TPS 130 through the front-end processor 132, as discussed above. The payment system selector 732 uses the order information to automatically identify applicable disbursement devices, access relevant requirements (including required data and permitted data values) as specified in the disbursement protocol data 732B, and generates an order to be provided to a recipient in the appropriate format. The payment system selector 732 then selects a channel to communicate with the appropriate back-end processor and provides configuration data 133 to the selected back-end processor. The back-end processor that receives the configuration data 133 provides order information to the recipient using similar techniques as discussed above.

In some implementations, the TPS 130 can integrate and interface with different disbursement devices for different types of transactions within the same country (e.g., domestic orders vs. cross-border orders), including different order credential input, authentication, authorization and settlement processes (carded vs. non-carded) on the same device. In such implementations, the order recipient can receive a dynamic disbursement device locator so that the recipient is directed to the correct disbursement devices.

If the payment system selector 732 receives an order data value from the sending entity system 110 that is inconsistent with data requirements stored in the disbursement protocol data 732B, the payment system selector 732 can reject the order submission, and optionally, provide a prompt to the sending entity system 110 (via the front-end processor 132) to correct the data to a permissible order submission for the applicable disbursement platform. In this way, a sending entity can use the TPS 130 system to submit and generate orders redeemable at disparate disbursement devices in different countries without having to have specific knowledge of the specific requirements and processes applicable to each disparate disbursement device in each country. Additionally, a sending entity can customize order submission data set for each disparate disbursement platform or device based on the information stored in the disbursement protocol data 732B.

The TPS 130 can also be used to facilitate legal and regulatory compliance when disbursing funds to recipients that are located in different countries. For example, in certain countries or for certain types of transactions, local regulations may require an operator of the cash disbursement platform or devices to capture or have access to specific information regarding the identification of the recipient beyond a core identifier (e.g., a recipient's mobile phone number). In this example, the TPS 130 can use a separate communication to the recipient to prompt the recipient to input necessary additional information and communicate the information to the payment system selector 732 for storage in the disbursement protocol data 732B in connection with the specific transaction and recipient identifier.

As another example, the TPS 130 can require sending entities to collect necessary additional information prior to order submission and store and retain this information and make it available to the TPS 130 upon request. Alternatively, the TPS 130 can store the information in the disbursement protocol data 732B once a transaction order is received from the sending entity.

In some instances, the TPS 130 may collect and store necessary additional information from the recipient or from another source separate from the sending entity. In such instances, the TPS 130 may hold an order and only transmit the order to the recipient upon receipt of the necessary additional information.

In some implementations, the TPS 130 may maintain a “whitelist” of identifiers (e.g., phone numbers) for approved recipients whose necessary additional information has already been obtained. The TPS 130 would then implement the techniques discussed above to obtain the additional information on “new” order recipients that are not included in the whitelist. Depending on the data model used, the TPS 130 may also either share the whitelist with the disbursement devices 150A and 150B and/or the sending entity system 110 so that they do not need to collect the information again from that whitelisted order recipient. Alternatively, the TPS 130 may use the whitelist to only implement the prompt or other process to obtain the additional information for a new order recipient that will then be added to the whitelist after providing the necessary information.

As part of its integration with each disbursement device, the TPS 130 can provide disbursement devices with base configurations, including requirements to display screens to prompt the order recipient for the appropriate credentials, to transmit those credentials to the TPS 130, or to receive authentication of credentials from the TPS 130. These requirements, however, can be customized as described above for the unique methods, protocols and processes applicable to each disbursement platform. Where necessary, the disbursement protocol data 732B can be updated for the requirements of a specific disbursement platform.

The TPS 130 can also provide each disbursement device 150 with the requirements to disburse funds using an appropriate process, such as non-carded process where the disbursement device disburses funds based solely upon the authorization from the TPS 130 and then settlement is handled separately by the TPS 130 between a sending entity and a disbursing entity. As another example, the process may involve a carded process where the TPS 130 delivers a one-time use payment card number or token to a disbursement device 150 for authorization, clearing and settlement through a payment network 103.

For security purposes, the system will typically use the PAN token process as described above (FIG. 2A) to identify the sending entity funding account regardless of the unique requirements of the targeted disbursement platforms and devices. If desired, the same PAN token can be used for orders being disbursed across disparate disbursement platforms and devices. Similarly, if VCNs are used in the settlement process for the particular disbursement platforms and devices, then for security purposes, the system will typically use the VCN token process as described above (FIG. 3A-1, 3A-2 and 3A-3). Where the VCNs are used, the VCNs can be issued in the currency of the targeted disbursement platforms and devices using either a common PAN token or separate PAN tokens, as desired.

In FIG. 7, the front-end processor 132 receives a transaction order 106 from the sending entity system 110. The transaction order 106 identifies a phone number of the recipient 101. The transaction order 106 is forwarded to the payment system selector 732, which determines that the back-end processor 734A should be used for processing the transaction. This determination is based on the phone number referencing a recipient device that is located in the United States, as opposed to a recipient device that is located in Spain. Alternatively, the transaction order 106 can specify the country or region in which the order may be disbursed. In that case, the payment system processor 132 will direct the order to the applicable back end processor 734 for that country or region. In this manner, an order recipient who needs emergency cash in a foreign country can receive an order to his or her mobile phone which may be disbursed at eligible disbursement devices in the foreign country.

The payment system selector 732 generates configuration data 133 for the back-end processor 734A based on data stored in the disbursement protocol data 732B for disbursement devices that are located in the United States. For example, as discussed above, the payment system selector 732 can identify compliance protocols for the United States, any U.S. dollar currency restrictions (e.g., maximum value for a transaction that does not require generating currency transaction report), and security regulations imposed on disbursement platforms that are located in the United States.

The back-end processor 734A receives configuration data 133 from the payment system selector 732 and configures the disbursement device 150A to process a transaction corresponding to the transaction order 106. As discussed above, the recipient can then access the disbursement device 150A to submit credential information (e.g., phone number of the recipient device, transaction amount, transaction identifier, secret code) for transaction authentication, as discussed above.

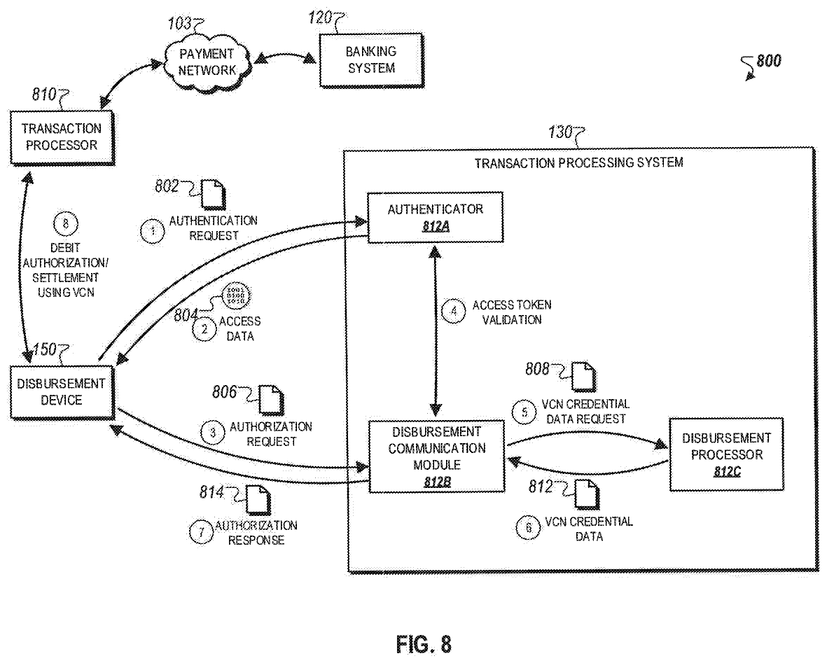

FIG. 8 illustrates an example of a system 800 for processing direct connection card-less transactions. In this example, the disbursement device 150 is managed by an independent service provider (e.g., an individual ATM owner) who elects to connect its disbursement devices 150 directly to the TPS 130 instead of connecting through the transaction processor who may process the independent service provider's standard ATM transactions (e.g., the processor may not support the card-less transactions). This introduces additional transaction security risks since the disbursement devices 150 are connecting to a new third-party system in the form of the TPS 130 and receiving disbursement and other instructions from this new system. Therefore, it is essential that these connections be secure.

To address these security risks, the system 800 is configured to employ validation techniques that improve the likelihood that the disbursement device 150 communicating with the TPS 130 is a valid disbursement device 150 and the system communicating with the disbursement device 150 is actually the TPS 130. In this way, the participants can ensure that a disbursement request received from a disbursement device 150 and a disbursement instruction received by the disbursement device 150 is not fraudulent and thereby complies with security requirements of the banking system 120. Conventional transaction systems would be unable to reliably validate a disbursement request received at the disbursement device 150 without the use of some payment card. Thus, the system 800 provides the capability for a recipient to perform a transaction on an independently owned or managed disbursement device without presenting a payment card, and in a manner that ensures security to the banking system 120. This capability is enabled with the use of tokens, e.g., access token and a VCN token, to authenticate a recipient at the disbursement device 150 prior to authorizing a disbursement of funds and to actually authorize the disbursement of funds. The use of these tokens would not typically be employed in conventional transaction systems since such systems typically rely upon the use of payment cards for authentication. The system 800 therefore provides improvements over conventional transaction systems by providing a tokenized approach that does not rely upon payment cards, which represents an improvement in an existing technological process of transaction authentication at a disbursement device.

As shown in FIG. 8, the system 800 includes a transaction processor 810, a banking system 120, a payment network 103, a TPS 130, and a disbursement device 150. The TPS 130, in this example, includes an authenticator 812A, a disbursement communication module 812B, and a disbursement processor 812C. The transaction verification process proceeds in a set of stages.

Prior to authentication, the disbursement device 150 is initially registered with the TPS 130. In stage (1), the disbursement device 150 transmits an authentication request 802 to the TPS 130. The authentication request 802 includes information that identifies the disbursement device 150, such as a device identifier, a client identifier and a terminal identifier. The authenticator 812A processes the information and registers the device identifier of the disbursement device 150 in a registration database managed by the TPS 130. The device identifier can be associated with a unique client identifier of the service provider of the disbursement device 150.

In stage (2), once registration is complete, the TPS 130 provides access data 804 to the disbursement device 150 and software that permits data communications with the TPS 130. For example, the access data 804 can include a PEM-formatted certificate that is used to “sign” authorization requests that are provided to the TPS 130 in relation to disbursement requests received at the disbursement device 150. The access data 804 can also include a symmetric encryption key that is used to encrypt/decrypt sensitive fields (e.g. PCI-related data) that are passed between the disbursement device 150 and the TPS 130 during, for example, transaction authorization. The access data can have a limited life span (e.g., 5 minutes) and is used during transaction order authorization to confirm that the disbursement device 150 has been successfully authenticated.

Due its limited live span, the access data 804 is granted by the TPS 130 to the disbursement device 150 during an initial registration phase, as well as each subsequent communication, e.g. during a process for authorizing a transaction received at the disbursement device 150. After the initial registration, the disbursement device 150 is included in a set of eligible disbursement devices that are provided to the recipient when receiving a communication regarding a card-less transaction.

After stage (2), the disbursement device 150 and the TPS 130 are associated with one another in a registration database managed by the TPS 130. A record for the disbursement device 150 in the registration database may include a flag identifying the most recent access data, e.g., current symmetric key and certificate that was sent to the disbursement device 150. The flag can be reset by the authenticator 812A when needed to provide an update to the certificate and/or symmetric key, for example, during a subsequent communication with the disbursement device 150 involving transaction authorization.

In stage (3), the disbursement device 150 provides an authorization request 806 to the TPS 130 when a recipient attempts a card-less transaction at the disbursement device 150. The recipient can perform the card-less transaction in a similar manner as discussed above in reference to FIGS. 3A-1, 3A-2, 3A-3, and 3B. The authorization request 806 can include, for example, a signed certificate, symmetric key, and access token that was received in the access data 804 from the TPS 130. The authorization request 806 also includes transaction identification information, such as a phone number of the recipient, a transaction amount, a transaction identifier, and a secret code that was distributed to the recipient 101 from the sending entity system 110.

In stage (4), the authenticator 812A validates the access token. For example, the authenticator 812A receives access data included in the authorization request 806 from the disbursement communication module 812B and compares the received access data to the verified access data maintained by the authenticator 812A. If the authorization request 806 is valid, then the access data included in it will match the verified access data that is maintained by the authenticator 812A and included in the access data 804 provided to the disbursement device 150. The authenticator 812A also validates order information included with the authorization request 806 by comparing transaction identification information received to verified transaction identification information previously stored in the TPS 130 for the applicable order. If an order is validated, the authenticator 812A determines that the transaction order is available for disbursement.

In stage (5), the disbursement communication module 812B transmits a VCN credential data request 808 to the disbursement processor 812C. In response, the disbursement processor 812C obtains a VCN that was previously generated for a transaction order corresponding to the authorization request 806, as discussed above in reference to FIGS. 3A-1, 3A-2, and 3A-3. The disbursement processor 812C then obtains the VCN from the banking system 120.

In stage (6), the disbursement processor 812C transmits VCN credential data 812 to the disbursement communication module 812B. The VCN credential data 812 includes for example, the VCN, an expiration date of the VCN, and card verification value (CVV2) number. The information in the VCN credential data 812 is encrypted using the symmetric key discussed above.

In stage (7), the disbursement communication module 812B transmits an authorization response 814 in response to the authorization request 806. The authorization response 814 includes the VCN credential data 812 obtained by the disbursement processor 812C. The authorization response 814 may be sent with a default PIN value, which is required to be present, but not validated, during order processing by the disbursement device 150. The VCN and other data in the authorization response 814 may be encrypted by the TPS 130 prior to transmission to the disbursement device 150 and then decrypted by the disbursement device 150 using the key previously provided to the disbursement device 150 by the TPS 130.

At the step (8), the disbursement device 150 performs debit authorization and settlement with a transaction processor 810 and the banking system 120 via the payment network 103 using the VCN. The disbursement device 150 uses the VCN in a similar way as a card number associated with an actual payment card used by a cardholder at a disbursement device. For example, the VCN can be used as a debit card that identifies a funding account from which funds are disbursed for the transaction.

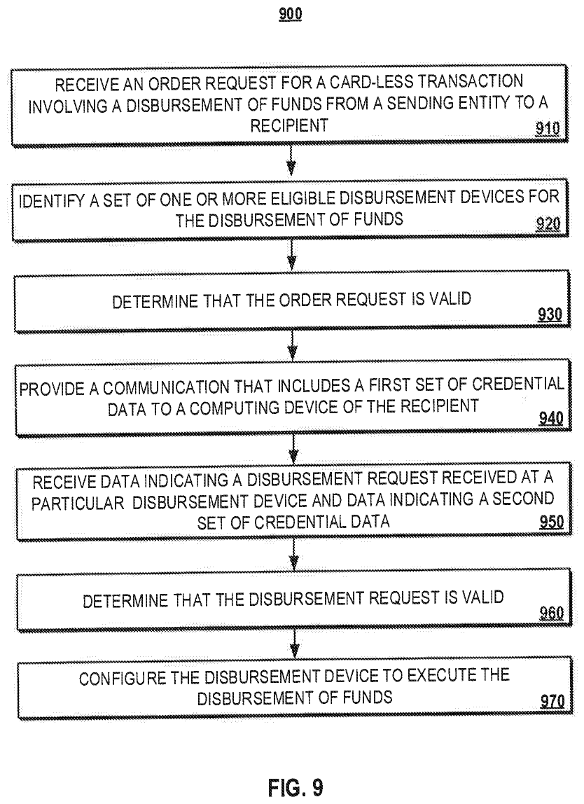

FIG. 9 illustrates an example of a process 900 for processing a card-less transaction. The process 900 can include receiving an order request for card-less transaction involving a disbursement of funds from a sending entity to a recipient (910). For example, the TPS 130 receives an order request 106 from the sending entity system 110. The order request 106 specifies a disbursement from funds from a sending entity to a recipient 101. As discussed above, the order request 106 can include a first set of credential data, such as a phone number of a recipient device 140 associated with the recipient 101, a transaction value, a secret code, and an expiration date for performing the transaction. The order request 106 can also include a PAN token 104 that is uniquely associated with a funding account 122 of the sending entity with the banking system 120.

The process 900 can include identifying a set of one or more eligible disbursement devices for the disbursement of the funds (920). The set of one or more eligible disbursement devices can include a disbursement device 150 that has been configured by the TPS 130 to receive a disbursement request from the recipient 101 in relation to the transaction order 106. The eligible disbursement devices can include disbursement devices managed by a service provider that has agreed to participate in a card-less transaction program in which transactions are managed by the TPS 130. The eligible disbursement devices can be pre-configured with software that enables them to exchange data communications with the TPS 130, such as exchanging transaction identification information for authentication, exchanging a VCN for settlement, or being configured to perform settlement with the banking system 120 over a payment network 103.

In some implementations, the eligible disbursement devices can be dynamically configurable by the TPS 130 based on the type of transaction to be performed. For example, the TPS 130 may manage transactions having different security or other requirements specified by the operator of the TPS 130, the service provider managing the disbursement device 150 and/or the banking system 120. Once a transaction is attempted at an eligible disbursement device, the TPS 130 can determine applicable security protocols to be used in verifying the transaction attempt at the eligible disbursement device 150 and dynamically configure the eligible disbursement using the applicable security protocols. The eligible disbursement device 150, in these implementations, can be configured with customizable software that adjusts its operation depending on the type of transaction being performed by the recipient.

The process 900 can include determining that the order request is valid (930). For example, the TPS 130 can determine that the order request 106 is valid based on the PAN token 104, the transaction order information (e.g., the specified currency, transaction value, other required information, etc.) and the identification of the set of one or more eligible devices for the disbursement of the funds. As discussed above, the TPS 130 can validate the order request 106 if, among other things, the PAN token included with the order request 106 matches a verified PAN token that is stored by the TPS 130 and associated with a participating sending entity and was generated during an initial registration phase depicted in FIG. 2A.

The process 900 can include providing a communication that includes a first set of credential data to a computing device of the recipient (940). For example, the TPS 130 can provide a communication to the recipient device 140 of the recipient 101. The communication can be, for example, a SMS text message that is sent to a phone number associated with the recipient device 140. In other examples, the communication can be sent over other channels, such as email, a mobile application, a messaging application, a social media network, among others. The communication can include the first set of credential data included in the transaction order and identify the set of one or more eligible disbursement devices.

The process 900 can include receiving data indicating a disbursement request received at a particular disbursement device and data indicating a second set of credential data (950). For example, the TPS 130 can receive data indicating a disbursement request received at the disbursement device 150. The disbursement request can be provided by the recipient 101 and include the transaction identification information 114, which represents a second set of credential data. The transaction identification information 114 can include information submitted by the recipient 101 at the disbursement device 150, such as a phone number of the recipient device 140, a transaction value, a secret code received from the sending entity system 110, and a transaction identifier.

The process 900 can include determining that the disbursement request is valid (960). For example, the TPS 130 can determine that the disbursement request is valid if the transaction identification information 114 submitted at the disbursement device 150 matches verified transaction information stored by the TPS 130. The verified transaction information can be included in an order request 106 received from the sending entity system 110. In some instances, the transaction identification information 114 includes a phone number of the recipient device 140, a transaction identifier generated by the TPS 130, a transaction value for the disbursement of funds, and a secret code provided to the recipient device 140. As discussed above, the TPS 130 evaluates the transaction identification information 114 to authenticate the recipient 101 without requiring the recipient 101 to present a payment card at the disbursement device 150.

The process 900 can include configuring the disbursement device to execute the disbursement of funds (970). For example, once the TPS 130 has determined that the disbursement request received at the disbursement device 150 is valid, the TPS 130 configures the disbursement device 150 to execute the disbursement of funds specified by the card-less transaction. As discussed above in FIGS. 3A-1, 3A-2, and 3A-3, in some implementations, the configuration involves the use of a VCN that is used for transaction settlement between the disbursement device 150 and a banking system 120 over a payment network 103. In such implementations, the TPS 130 directs the banking system 120 to provide a VCN 118 by transmitting to the banking system 120 a corresponding VCN token 119 for the transaction. The TPS 130 then relays the VCN 118 to the disbursement device 150 (without storing the VCN 118 for extended time periods, such as after transaction settlement has been completed). The TPS 130 provides the VCN in an encrypted format and the disbursement device 150 decrypts the VCN using a key previously stored by the TPS 130 in the software of the disbursement device 150. The disbursement device 150, in such implementations, then uses the VCN 118 to perform transaction settlement with the banking system 120.

In other implementations, as discussed above in FIG. 3B, once the TPS 130 has determined that the disbursement request received at the disbursement device 150 is valid, the TPS 130 transmits a settlement instruction to the banking system 120 to initiate transaction settlement with the disbursement device 150 over the payment network 103. In these implementations, the TPS 130 is capable of directing transaction settlement without the use of a VCN. In some instances, settlement instructions provided by the TPS 130 can be provided in real-time for each individual transaction to improve the speed of transaction processing at the disbursement device 150. In other instances, a bulk settlement instruction can be periodically provided for multiple transactions to perform transaction settlement for the multiple transactions at one instance.

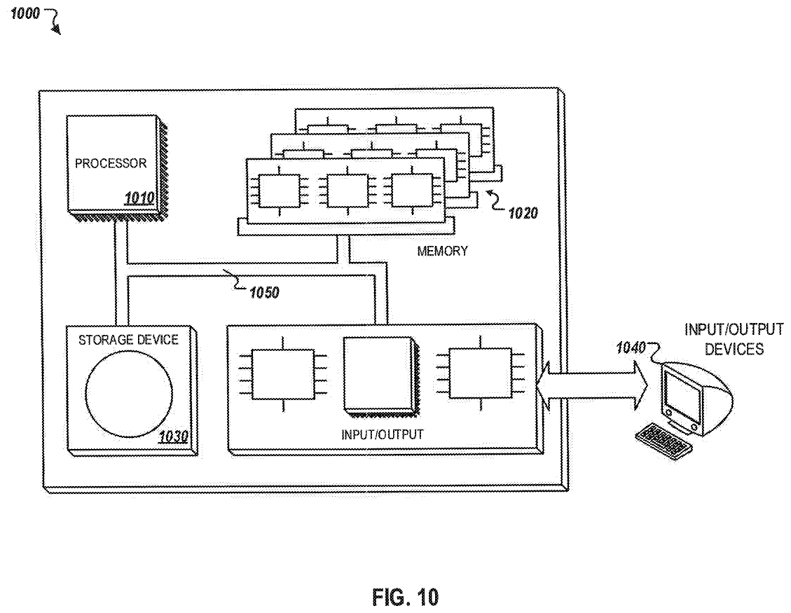

FIG. 10 illustrates an example of a system 1000. The system 1000 can be used to carry out the operations described in association with any of the computer-implemented methods described previously, according to some implementations. In some implementations, computing systems and devices and the functional operations described in this specification can be implemented in digital electronic circuitry, in tangibly embodied computer software or firmware, in computer hardware, including the structures disclosed in this specification (e.g., system 1000) and their structural equivalents, or in combinations of one or more of them. The system 1000 is intended to include various forms of digital computers, such as laptops, desktops, workstations, personal digital assistants, servers, blade servers, mainframes, and other appropriate computers, including vehicles installed on base units or pod units of modular vehicles. The system 1000 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transmitter or USB connector that can be inserted into a USB port of another computing device.

The system 1000 includes a processor 1010, a memory 1020, a storage device 1030, and an input/output device 1040. Each of the components 1010, 1020, 1030, and 1040 are interconnected using a system bus 1040. The processor 1010 is capable of processing instructions for execution within the system 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the system 1000. In one implementation, the input/output device 1040 includes a keyboard and/or pointing device. In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of embodiments have been described. Nevertheless, it will be understood that various modifications can be made without departing from the spirit and scope of the invention. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A computer-implemented method comprising:
receiving, by a server system and from a computing system of a sending entity, an order for a card-less transaction involving a disbursement of funds from the sending entity to a recipient, the order comprising (i) a first set of credential data associated with the card-less transaction, and (ii) a first token that is uniquely associated with a funding account of the sending entity;
identifying, by the server system, a set of one or more eligible disbursement devices for the disbursement of the funds;
determining, by the server system, that the order is valid based at least on the first token and the identification of the set of one or more eligible disbursement devices for the disbursement of the funds;
providing, by the server system and to a computing device associated with the recipient, a communication that includes at least the first set of credential data associated with the card-less transaction and identifies the set of one or more eligible disbursement devices;
receiving, by the server system and from a particular disbursement device from among the set of one or more eligible disbursement devices, data indicating (i) a disbursement request received at the particular disbursement device, and (ii) a second set of credential data received at the particular disbursement device in association with the disbursement request;
determining, by the server system, that the disbursement request is valid based on at least a comparison of the first set of credential data and the second set of credential data; and
configuring, by the server system, the particular disbursement device to execute the disbursement of funds specified by the card-less transaction based on (i) the determination that the order is valid and (ii) the determination that the disbursement request is valid.

2. The method of claim 1, wherein:
The funding account of the sending entity is associated with a banking computing system that is managed by a banking entity; and
the server system is managed by a third-party service provider that is independent and distinct from the sending entity and the banking entity.

3. The method of claim 2, wherein validating the order comprises:
obtaining, by the server system and from the banking computing system, a verified token corresponding to the funding account of the sending entity;
determining that the first token matches the verified token; and
determining, by the server system, that the order is valid based on at least determining that the first token matches the verified token.

4. The method of claim 2, further comprising:
providing, by the server system and to the banking computing system, an instruction to create a virtual payment card number that (i) is specific to the card-less transaction and (ii) configured to be used by the particular disbursement device to perform transaction authorization and settlement in association with the disbursement request; and
receiving, by the server system and from the banking computing system responsive to providing the request for the virtual payment card number, data indicating a second token uniquely associated with the virtual payment card number.

5. The method of claim 4, wherein configuring the particular disbursement device comprises:
receiving, by the server and from the particular disbursement device, data indicating the disbursement request received at the particular disbursement device;
based on receiving the data indicating the disbursement request received at the particular disbursement device, providing, by the server system, the second token to the banking computing system;
receiving, by the server system and from the banking computing system, the virtual payment card number created by the banking computing system for the card-less transaction;
providing, by the server system and to the particular disbursement device, an instruction that includes the data indicating the virtual payment card number corresponding to the order and identifying the banking computing system; and
wherein the instruction, when received by the particular disbursement device, causes the particular disbursement device to: (i) perform transaction authorization and settlement in association with the disbursement request using the virtual payment card number, and (ii) execute the disbursement of funds specified by the card-less transaction based on performance of the transaction authorization and settlement.

6. The method of claim 5, further comprising:
after providing the instruction that includes the virtual payment card number to the particular disbursement device, deleting, by the server system, any data instances representing the virtual payment card number at the server system; and
storing, by the server system, the first token and the second token in a record for the card-less transaction within an order repository.

7. The method of claim 2, wherein configuring the particular disbursement device comprises:
identifying a service provider that manages the particular disbursement device; and
providing, by the server system and to the banking computing system, an instruction to perform transaction settlement with the service provider that manages the particular disbursement device.

8. The method of claim 1, wherein the first set of credential data comprises:
a phone number of a computing device associated with the recipient;
a transaction value of the card-less transaction; and
a secret code generated for the card-less transaction by sending entity.

9. The method of claim 8, wherein:
the method further comprises generating, by the server system, a transaction identifier of the card-less transaction based on the first set of credential data;
the communication provided to the computing device associated with the recipient specifies the transaction identifier of the card-less transaction; and
the second set of credential data comprises:
a transaction identifier specified by the recipient at the particular disbursement device;
a transaction value specified by the recipient at the particular disbursement device;
an identifier associated with the particular disbursement device; and
a secret code provided to the recipient in association with the card-less transaction.

10. The method of claim 1, wherein identifying the set of one or more eligible disbursement devices for the disbursement of the funds comprises:
determining a location of the computing device associated with the recipient; and
identifying one or more eligible disbursement devices within a threshold proximity to the location of the computing device associated with the recipient.

11. The method of claim 10, further comprising:
providing, by the server system and to the computing device of the recipient, a communication indicating the one or more eligible disbursement devices that are identified to be within the threshold proximity to the location of the computing device associated with the recipient.

12. The method of claim 2, wherein determining that the order is valid comprises determining that the funding account of the sending entity contains sufficient funds for creation of the order.

13. The method of claim 12, further comprising, after determining that the order is valid:
generating, by the server system, an instruction that, when received by a computing system associated with the funding account of the sending entity, causes the computing system associated with the funding account of the sending entity to reduce available funds associated with the funding account pending the disbursement of funds specified by the card-less transaction; and
providing, by the server system, the instruction for output to the computing system associated with the funding account of the sending entity.

14. The method of claim 13, wherein the instruction comprises an expiration date that causes the computing system associated with the funding account of the sending entity to reverse reduction of the available funds associated with the funding account if funds specified by the card-less transaction have not been disbursed by the expiration date.

15. A computer-implemented method comprising:
obtaining, by a server system, data indicating a disbursement device to be used for a disbursement of funds;
generating, by the server system, a first set of access credentials for the disbursement device;
providing, by the server system, the first set of access credentials to the disbursement device;
after providing the first set of access credentials to the disbursement device, receiving, by the server system and from the disbursement device, a second set of access credentials included with a disbursement request received at the disbursement device;
determining, by the server system, that the disbursement request is valid based on the first set of access credentials and the second set of access credentials; and
providing, by the server system, an access token to the disbursement device based on the determination that the disbursement request is valid.

16. The method of claim 15, wherein:
the first set of access credentials comprises a verified digital certificate and a verified symmetric key for the disbursement device;
the second set of access credentials comprises a digital certificate included with the disbursement request received at the disbursement device and encryption data encrypted with the verified symmetric key; and
determining that the disbursement request is valid comprises:
determining that the digital certificate included with the disbursement request matches the verified digital certificate, and
determining that the encryption data matches data stored by the server system for the transaction.

17. The method of claim 15, wherein:
the access token is valid for a specified time period; and
the disbursement device, upon receiving the access token, is configured to (i) permit the disbursement of funds during the specified time period, and (ii) deny the disbursement of funds after the specified time period.

18. The method of claim 1, wherein the disbursement device is managed by a service provider that is independent and distinct from an entity that manages the server system.

19. A system comprising:
one or more computers; and
one or more storage devices storing instructions that, when executed by the one or more computers, cause the one or more computers to perform operations comprising:
receiving, by the one or more computers and from a computing system of a sending entity, an order for a card-less transaction involving a disbursement of funds from the sending entity to a recipient, the order comprising (i) a first set of credential data associated with the card-less transaction, and (ii) a first token that is uniquely associated with a funding account of the sending entity;
identifying, by the one or more computers, a set of one or more eligible disbursement devices for the disbursement of the funds;
determining, by the one or more computers, that the order is valid based at least on the first token and the identification of the set of one or more eligible disbursement devices for the disbursement of the funds;
providing, by the one or more computers and to a computing device associated with the recipient, a communication that includes at least the first set of credential data associated with the card-less transaction and identifies the set of one or more eligible disbursement devices;
receiving, by the one or more computers and from a particular disbursement device from among the set of one or more eligible disbursement devices, data indicating (i) a disbursement request received at the particular disbursement device, and (ii) a second set of credential data received at the particular disbursement device in association with the disbursement request;
determining, by the one or more computers, that the disbursement request is valid based on at least a comparison of the first set of credential data and the second set of credential data; and
configuring, by the one or more computers, the particular disbursement device to execute the disbursement of funds specified by the card-less transaction based on (i) the determination that the order is valid and (ii) the determination that the disbursement request is valid.

20. The system of claim 19, wherein:
The funding account of the sending entity is associated with a banking computing system that is managed by a banking entity; and
the one or more computers are managed by a third-party service provider that is independent and distinct from the sending entity and the banking entity.
